(19) United States
(12) Patent Application Publication
(10) Pub. No.: US 2025/0084885 A1
(43) Pub. Date: Mar. 13, 2025

(54) SINGLE-SIDE FASTENER

(71) Applicant: Kwikbolt Limited, Isleworth (GB)

(72) Inventor: Jan Niklewicz, Kingston Upon Thames (GB)

(73) Assignee: Kwikbolt Limited, Isleworth, MD (GB)

(21) Appl. No.: 18/691,360

(22) PCT Filed: Sep. 16, 2022
(86) PCT No.: PCT/IB2022/058782

§ 371 Date: Mar. 12, 2024

(30) Foreign Application Priority Data
Sep. 16, 2021 (GB) 2113220.4
Sep. 16, 2021 (GB) 2113223.8
Sep. 16, 2021 (GB) 2113225.3

(51) Int. Cl. F16B 19/10

(52) U.S. Cl. CPC F16B 19/109

(57) ABSTRACT

First, please substitute the abstract on the attached new sheet.

Second, please substitute the specification with that shown in the attached Substitute Specification, which includes both clean and markedup copies. The substitute specification moves the text from the originally filed claims into an embodiments section and makes some minor changes referring to claims into references to embodiments.

### FIELD OF THE INVENTION

This invention relates in general to the field of fasteners for use in clamping components and, in particular, to a temporary single-sided fastener which can be used in apertures where it is not possible to access the reverse of the components.

### BACKGROUND OF THE INVENTION

Temporary fasteners are used during the fabrication of complex structures such as aircraft frames to align components before permanent fasteners are installed. The number and location of the temporary fastenings will vary between applications, but for a typical wing set, i.e. two complete wings, for a large commercial passenger aircraft, the number of temporary fastenings used can reach around 25,000. It is convenient for such temporary fasteners to be operated from one side of the work-piece only, i.e. to insert and activate the fastener from above the work-piece without having to hold a part of the fastener from the underside of the work-piece, as would be the case for a nut and bolt, because often it is not possible to access both sides of the pieces being clamped simultaneously.

Fasteners that operate from one side are called “blind” fasteners and they typically can have a threaded part that carries a set of expandable legs. In some examples, the legs have protruding heads for applying the clamping load and the legs can be expanded when inserted into an aperture and drawn towards the work-piece by rotation of the threaded part until the desired clamping load is achieved. When the fastener is no longer required, the legs can be retracted to allow removal of the fostered by rotation of the threaded part in the opposite direction.

However, a problem with known fasteners is that the fasteners can be damaged upon removal by over-rotation of the threaded part in the loosening direction. In particular, the use of mechanical means for rotation of the threaded part, e.g. an air impact wrench, can cause damage to the threaded part of the fastener. Existing attempts to solve this problem result in a relative movement between a rotatable head of the threaded portion and a main body of the fastener. Such relative movement can cause difficulty in positioning a rotary tool for rotation of the threaded part, especially for automated systems.

As such, there is a need for an improved single-sided fastener. The present invention aims to address this need.

### SUMMARY OF THE INVENTION

According to a first aspect of the present invention, there is provided a fastener according to embodiment 1.

According to a second aspect of the present invention, there is provided a method of fastening a work piece according to embodiment 11.

According to a third aspect of the present invention, there is provided a fastener according to embodiment odiment 12.

According to a fourth aspect of the present invention, there is provided a method of fastening a work piece according to embodiment 25.

According to a fifth aspect of the present invention, there is provided a fastener according to embodiment 31.

According to a sixth aspect of the present invention, there is provided a method of fastening a work piece according to embodiment 45.

Optional features are as set out in other embodiments.

### BRIEF DESCRIPTION OF THE DRAWINGS

For a better understanding of the present invention and to show more clearly how it may be carried into effect, reference will now be made by way of example only, to the accompanying drawings, in which:

FIG. 1 is schematic diagram showing the components of a fastener according to an embodiment;

FIG. 2 is a schematic diagram showing a side elevation cross-section of a fastener according to an embodiment;

FIG. 3 is a schematic diagram showing a side elevation cross-section of a fastener according to an embodiment;

FIG. 4 is a schematic diagram showing a side elevation cross-section of a fastener according to an embodiment;

FIG. 5 is a schematic diagram showing a fastener in use according to an embodiment;

FIG. 6 is a schematic diagram showing a side elevation cross-section of a fastener in use according to an embodiment;

FIG. 7 is a schematic diagram showing a side elevation cross-section of a fastener in use according to an embodiment; and

FIG. 8 is a schematic diagram showing a side elevation cross-section of a fastener in use according to an embodiment.

FIGS. 9 and 10 are omitted.

FIG. 11 is schematic diagram showing the components of a fastener according to an embodiment;

FIG. 12 is a schematic diagram showing a fastener according to an embodiment in use;

FIG. 13 is a schematic diagram showing a fastener according to an embodiment in use;

FIG. 14 is a schematic diagram showing a fastener according to an embodiment in use;

FIG. 15 is a schematic diagram showing a fastener according to an embodiment in use;

FIG. 16 is a schematic diagram showing a fastener according to an embodiment in use;

FIG. 17 is a schematic diagram showing a fastener according to an embodiment in use;

FIG. 18 is a schematic diagram showing a fastener according to an embodiment in use;

FIG. 19 is a schematic diagram showing a fastener according to an embodiment in use; and

FIG. 20 is a schematic diagram showing a fastener according to an embodiment in use.

FIG. 21 is schematic diagram showing the components of a fastener according to an embodiment;

FIG. 22 is a schematic diagram showing a proximal end of the fastener according to an embodiment;

FIG. 23 is a schematic diagram showing a cross-section of the fastener according to an embodiment;

FIG. 24 is a schematic diagram showing a side elevation cross-section of the fastener of an embodiment in use;

FIG. 25 is a schematic diagram showing a side elevation cross-section of the fastener of an embodiment in use;

FIG. 26 is a schematic diagram showing a side elevation cross-section of the fastener of an embodiment in use;

FIG. 27 is schematic diagram showing the components of a fastener according to an embodiment;

FIG. 28 is a schematic diagram showing a cross-section of the fastener according to an embodiment;

FIG. 29 is a schematic diagram showing a side elevation cross-section of the fastener of an embodiment in use;

FIG. 30 is a schematic diagram showing a side elevation cross-section of the fastener of an embodiment in use; and

FIG. 31 is a schematic diagram showing a side elevation cross-section of the fastener of an embodiment in use.

### DETAILED DESCRIPTION OF THE INVENTION

The present invention relates to a fastener. In particular, the invention relates to a single-sided temporary fastener including a free-spin feature, which can prevent damage to the fastener on removal.

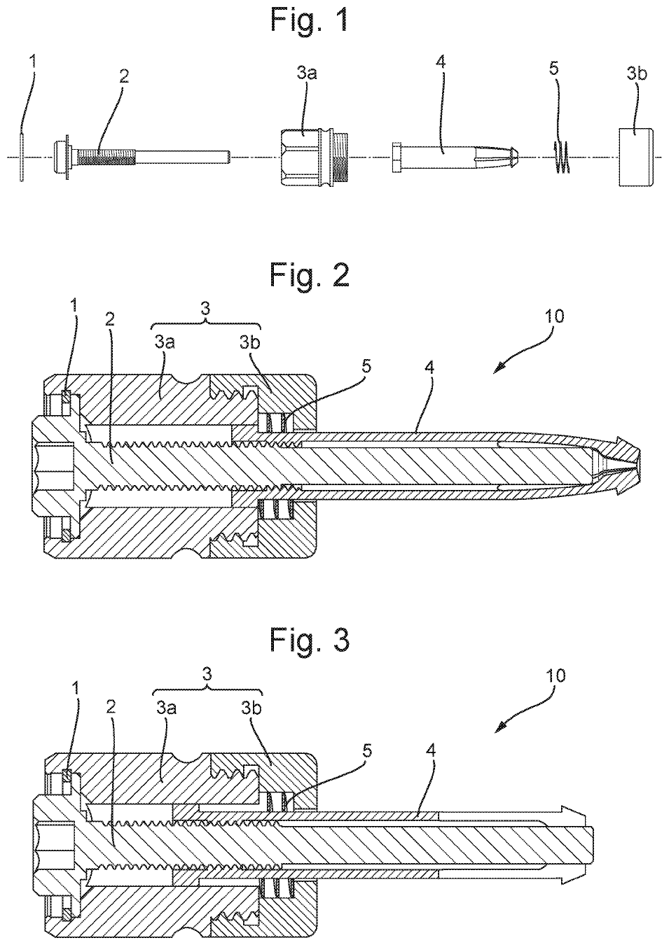

FIG. 1 of the accompanying drawings shows a fastener 10 comprising a retaining ring 1, a bolt 2, a first hollow tubular body part 3a, a hollow leg member 4, a spring 5 and a second hollow tubular body part 3b. Each of the components has a central axis, about which the component is substantially symmetric. The components are configured to form the fastener 10 when assembled. In some examples, the central axis of each component is aligned when the fastener 10 is assembled. Each of the components has a distal end, defined as the end furthest from the user in normal use, and a proximal end defined as the end closest to the user in normal use. The assembled fastener 10 has a corresponding distal end and proximal end.

The retaining ring 1 has a ring shape with a central opening. In some embodiments, the retaining ring 1 may have a substantially flat profile. In some examples, the retaining ring 1 may be a stamped circlip or a spiral snap ring, e.g. a Spiralox® retaining ring.

The bolt 2 has a substantially cylindrical shape. The bolt 2 has a proximal end and a distal end. The bolt 2 comprises a threaded portion at the proximal end. In some embodiments, the bolt 2 may have an external thread. A thread of the threaded portion may extend radially outwards from a central cylindrical portion. Alternatively, the thread may be cut radially inwards into the central cylindrical portion. The threaded portion of the bolt 2 is configured to engage with a threaded portion of the hollow leg member 4.

In some embodiments, the proximal end of the bolt 2 may have a flange. The flange of the bolt 2 may be configured to engage with the first hollow tubular body part 3a to limit a position of the bolt 2.

The first hollow tubular body part 3a is configured to form a hollow tubular body 3 with the second hollow tubular body part 3b. The first hollow tubular body part 3a may be referred to as a proximal tube. The second hollow tubular body part 3b may be referred to as a cap. In some embodiments, the first hollow tubular body part 3a and second hollow tubular body part 3b may be screwed together. Alternatively, the first hollow tubular body part 3a and second hollow tubular body part 3b by a press-fit, welding, adhesive any other suitable means. In some embodiments, the hollow tubular body 3 is formed as a single piece.

The hollow tubular body 3 has a proximal end and a distal end. The proximal end may be formed by the first hollow tubular body part 3a and the distal end may be formed by the second hollow tubular body part 3b. The distal end of the hollow tubular body 3 may be a flat surface perpendicular to the central axis or may have a conical (or “countersunk”) profile. The hollow tubular body 3 has a central axis. In some embodiments, the central axis of the hollow tubular body 3 defines the central axis of the fastener 10. The hollow tubular body 3 has a central opening extending along the central axis from the proximal end to the distal end. The hollow tubular body 3 is configured to receive the retaining ring 1, the bolt 2, the hollow leg member 4 and the spring 5 within the central opening.

The hollow leg member 4 has a hollow, substantially cylindrical form. The hollow leg member 4 has a proximal end and a distal end. The hollow leg member 4 comprises a flange at the proximal end, a threaded portion at the proximal end and a plurality of resilient legs at the distal end. The flange extends radially outwards from the proximal end of the flange. In some embodiments, the flange of the hollow leg member 4 may include a flat surface perpendicular to the central axis of the fastener. The flat surface of the flange may face the distal direction.

Each of the resilient legs of the hollow leg member 4 has a head at the distal end. The head may be formed as a flange portion extending radially outwards from the leg. The head of each leg is configured to engage with a work-piece. For example, the head of each leg may be arranged to engage with a distal side of the work piece. As will be described later, the head may be configured to transfer a compressive force to the work piece.

In some embodiments, the resilient legs of the hollow leg member 4, may be formed to extend distally from the distal end of the hollow leg member 4. Alternatively, the legs may be formed by dividing the distal end of the hollow leg member 4. A portion of material may be removed from the hollow leg member 4 between each of the legs.

Each of the resilient legs of the hollow leg member is biased radially inwards towards the central axis. That is, the distal ends of the resilient legs may be angled or curved radially inwards towards the central axis. The resilient legs may be formed of a resilient material such that each of the legs can be deflected inwards or outwards by a deflecting force. Provided the amount of deflection does not exceed a material limit, the resilient legs may be configured to return to the original biased position if the deflecting force is removed. In some examples, the resilient legs may be biased by, for example, inward deflection of the legs beyond the material limit, or by applying heat treatment while the legs are restrained in the biased position, or by any suitable process.

In some embodiments, the spring 5 may be a compressive spring. In some examples, the spring 4 may an open coil spring, a disc spring, or any other suitably resilient or elastic element. The spring 5 may be configured to fit around the hollow leg member 4.

FIG. 2 of the accompanying drawings shows a fastener 10 in assembled form. As shown, the central axis of each component is aligned when the fastener 10 is assembled.

As shown, the first hollow tubular body part 3a may form a hollow tubular body 3 with the second hollow tubular body part 3b. The first hollow tubular body part 3a and second hollow tubular body part 3b may be screwed together.

The hollow tubular body 3 has a proximal end and a distal end. The proximal end may be formed by the first hollow tubular body part 3a and the distal end may be formed by the second hollow tubular body part 3b. The distal end of the hollow tubular body 3 may be a flat surface perpendicular to the central axis or may have a conical (or “countersunk”) profile. The hollow tubular body 3 has a central axis. In some embodiments, the central axis of the hollow tubular body 3 defines the central axis of the fastener 10. The hollow tubular body 3 has a central opening extending along the central axis from the proximal end to the distal end. As shown, each of the retaining ring 1, the bolt 2, the hollow leg member 4 and the spring 5 are at least partially received within the central opening.

The bolt 2 has a substantially cylindrical form. As shown, the bolt 2 may be arranged within the central opening of the hollow tubular body 3. The bolt 2 may extend by a distance beyond the distal end of the hollow tubular body 3. In some examples, the proximal end (or “head”) of the bolt 2 may protrude from the proximal end of the hollow tubular body 3. Alternatively, the head of the bolt 2 may be within the proximal end of the central opening. The proximal end of the bolt 2 may include an engaging element configured to engage with a rotary tool. For example, the head of the bolt 2 may be formed with a polygonal, e.g. hexagonal or square, shape for engagement with a wrench, or may include a socket or recess having a shape for engagement with a socket wrench, key, or screwdriver e.g. a hexagonal, triangular, square, linear, cross or star shaped recess.

In some embodiments, the proximal end of the bolt 2 may have a flange. The flange may be formed to extend radially outwards from the cylindrical body of the bolt 2. The flange of the bolt 2 may be configured to engage with the first hollow tubular body part 3a to limit a position of the bolt 2. For example, in some embodiments, the hollow tubular body 3 may have a shoulder arranged to block the bolt 2 from moving in a distal direction. As shown, the shoulder be be formed in the first hollow tubular body part 3a. The shoulder may be formed to extend radially inwards into the central opening of the hollow tubular body 3. The shoulder may be arranged to engage with the flange of the bolt 2, to fix the bolt in position with respect to the hollow tubular body 3.

In some embodiments, the hollow tubular body 3 may have a retaining means configured to engage with the flange of the bolt 2 and block the bolt 2 from moving in a proximal direction. For example, the first hollow tubular body part 3a may comprise a lip extending radially inwards into the central opening at or near the proximal end. In some embodiments, as shown, the retaining means may be provided by the retaining ring 1.

The retaining ring 1 has a ring shape with a central opening. In some embodiments, the retaining ring 1 may have a substantially flat profile. In some examples, the retaining ring 1 may be a stamped circlip or a spiral snap ring, e.g. a Spiralox retaining ring. As shown, the first hollow tubular body part 3a may comprise a retaining groove arranged to receive the retaining ring 2. The retaining groove may be positioned distally from the shoulder. The retaining ring 1 may be positioned in the retaining groove of the first hollow tubular body part 3a, and the flange of the bolt 2 may be located between the retaining ring 1 and the shoulder of the hollow tubular body 3.

The bolt 2 comprises a threaded portion at the proximal end. In some embodiments, the bolt 2 may have an external thread. A thread of the threaded portion may extend radially outwards from a central cylindrical portion. Alternatively, the thread may be cut radially inwards into the central cylindrical portion. The threaded portion of the bolt 2 is configured to engage with a threaded portion of the hollow leg member 4.

The hollow leg member 4 has a hollow, substantially cylindrical form. The hollow leg member comprises a plurality of resilient legs at the distal end. In some embodiments, the resilient legs of the hollow leg member 4, may be formed to extend distally from the distal end of the hollow leg member 4. Alternatively, the legs may be formed by dividing the distal end of the hollow leg member 4. A portion of material may be removed from the hollow leg member 4 between each of the legs.

As shown, the hollow leg member 4 may be arranged within the central opening of the hollow tubular body 3. The hollow leg member 4 may extend by a distance beyond the distal end of the hollow tubular body 3. The hollow leg member is translatable within the hollow tubular body 3 along the central axis of the hollow tubular body 3.

The hollow leg member 4 comprises a flange at the proximal end. The flange extends radially outwards from the proximal end of the flange. In some embodiments, the flange of the hollow leg member 4 may include a flat surface perpendicular to the central axis of the fastener. The flat surface of the flange may face the distal direction.

The hollow tubular body 3 comprises a stop portion extending radially inwards at the distal end. For example, the second hollow tubular body part 3b may be formed with a lip extending radially inwards into the central opening of the hollow tubular body 3. In some embodiments, the stop portion of the hollow tubular body 3 may have a corresponding flat surface perpendicular to the central axis of the fastener. The flat surface of the stop portion may face the proximal direction.

The spring 5 is arranged between the flange of the hollow leg member 4 and the stop portion of the hollow tubular body 3. In some embodiments, the spring 5 may be a compressive spring. In some examples, the spring 4 may an open coil spring, a disc spring, or any other suitably resilient or elastic element. The spring 5 may be configured to fit around a cylindrical portion of the hollow leg member 4 and abut with the distally facing flat surface of the flange. The spring 5 is configured to urge the hollow leg member 4 in a proximal direction with respect to the hollow tubular body 3. For example, the spring 5 may be configured to exert a force on the distally facing flat surface of the hollow leg member 4 and the proximally facing flat surface of the hollow tubular body 3.

In this way, the spring 5 and/or the stop portion of the hollow tubular body 3 may be configured to block the hollow leg member 4 from moving in the distal direction. In some embodiments, the distal ends of the legs may extend beyond the distal end of the bolt 2 when the hollow leg member 4 is in the most distal position, as shown in FIG. 2.

Each of the resilient legs of the hollow leg member 4 is biased radially inwards towards the central axis. That is, the distal ends of the resilient legs may be angled or curved radially inwards towards the central axis. In some examples, the resilient legs may be biased by, for example, inward deflection of the legs beyond the material limit, or by applying heat treatment while the legs are restrained in the biased position, or by any suitable process. As shown, a portion of the resilient legs which extends beyond the distal end of the bolt 2 may be angled or curved radially inwards.

The hollow leg member 4 comprises a threaded portion at the proximal end. In some embodiments, the hollow leg member 4 may have an internal thread. For example, the hollow leg member 4 may include a thread extending radially inwards from an inner wall of the hollow cylindrical form. Alternatively, the thread may be cut radially outwards into the inner wall of the hollow cylindrical form.

The threaded portion of the bolt 2 is configured to engage with a threaded portion of the hollow leg member 4. In this way, rotation of the bolt 2 in a first direction draws the hollow leg member 4 in a proximal direction along the central axis. The first direction may be referred to as a fastening, tightening or clamping direction. In some examples, the first direction may be clockwise from the perspective of the user. Alternatively, the first direction may be anti-clockwise. By rotation of the bolt 2 in the first direction, the hollow leg member 4 may be translated in a proximal direction relative to the bolt 2. The hollow leg member 4 may also be translated in a proximal direction relative to the hollow tubular body 3. In some examples, the hollow leg member 4 may be drawn further within the central opening of the hollow tubular body 3. In some examples, the resilient legs of the hollow leg member 4 may be moved in a proximal direction towards or past the distal end of the hollow tubular body 3.

FIG. 3 of the accompanying drawings shows the fastener 10 after rotation of the bolt 2 in the first direction. As shown, the hollow leg member 4 is translated in a proximal direction relative to the bolt 2. The resilient legs of the hollow leg member 4 do not extend beyond the distal end of the bolt 2. In this position, the distal end of the bolt 2 is configured to urge the resilient legs of the hollow leg member radially outwards.

In some embodiments, the resilient legs may be formed of a resilient material such that each of the legs can be deflected inwards or outwards by a deflecting force, e.g. by the bolt 2. Provided the amount of deflection does not exceed a material limit, the resilient legs may be configured to return to the original biased position if the deflecting force is removed.

Each of the resilient legs of the hollow leg member 4 has a head at the distal end. The head may be formed as a flange portion extending radially outwards from the leg. As shown, when the resilient legs are deflected outwards by the bolt 2, the head of each leg may protrude outwards beyond the radial extent of the hollow leg member 4.

The head of each leg is configured to engage with a work-piece. For example, the head of each leg may be arranged to engage with a distal side of the work piece. In some examples, the flange portion forming the head of each leg may include a flat surface which is presented perpendicular to the central axis and proximally facing when the hollow leg member 4 is in the position shown in FIG. 3. As will be described later, the head of each resilient leg may be configured to transfer a compressive force to the work piece.

Rotation of the bolt 2 in a second direction opposite to the first direction is configured to translate the hollow leg member 4 in a distal direction along the central axis. The second direction may be referred to as an unfastening, loosening or detaching direction. In some examples, where the first direction is clockwise from the perspective of the user, the second direction may be anti-clockwise and vice versa. By rotation of the bolt 2 in the second direction, the hollow leg member 4 may be translated in a distal direction relative to the bolt 2. The hollow leg member 4 may also be translated in a distal direction relative to the hollow tubular body 3. In some examples, the hollow leg member 4 may be pushed further out of the central opening of the hollow tubular body 3. In some examples, the resilient legs of the hollow leg member 4 may be moved in a distal direction away from the distal end of the hollow tubular body 3.

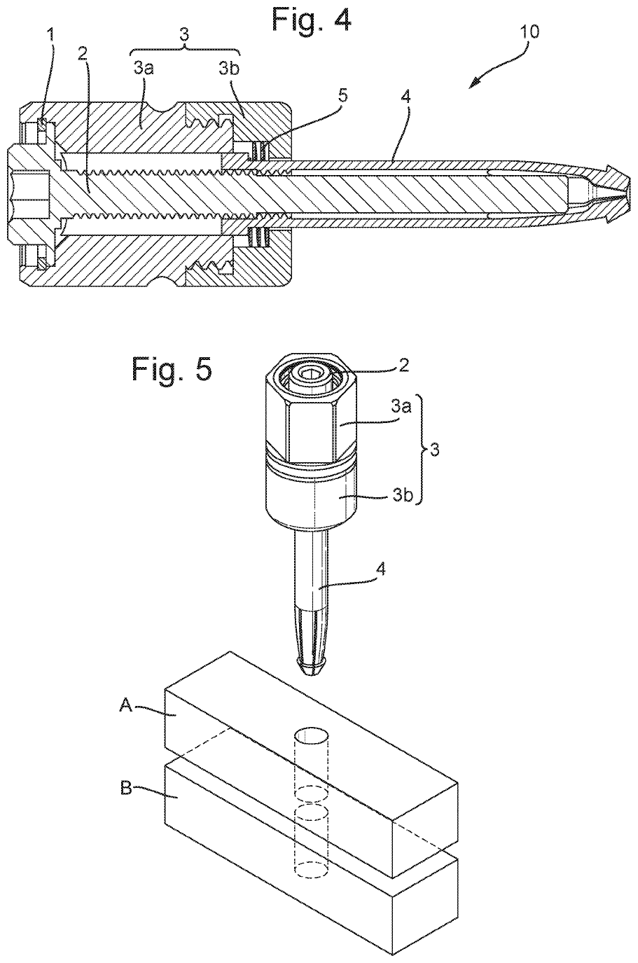

FIG. 4 of the accompanying drawings shows the fastener 10 after rotation of the bolt 2 in the second direction. Rotation of the bolt 2 in the second direction may first return the fastener 10 to the configuration of FIG. 2, and further rotation may lead to the configuration of FIG. 4.

As shown, the hollow leg member 4 is translated in a distal direction relative to the bolt 2. The resilient legs of the hollow leg member 4 extend beyond the distal end of the bolt 2. In this position, the distal end of the bolt 2 does not urge the resilient legs of the hollow leg member radially outwards. In some embodiments, the resilient legs may be formed of a resilient material such that each of the legs can be deflected inwards or outwards by a deflecting force. Provided the amount of deflection caused by the bolt 2 has not exceeded a material limit, the resilient legs may be configured to return to the original biased position when the bolt 2 is removed.

Rotation in the second direction causes the threaded portion of the hollow leg portion 4 to disengage from the threaded portion of the bolt 2. As the threaded portion of the bolt 2 is at the proximal end of the bolt 2, the threaded portion of the hollow leg portion 4 may be translated distally out of the threaded portion of the bolt 2. In this way, the threaded portion of the hollow leg portion 4 can be disengaged from the threaded portion of the bolt 2. In this configuration, the bolt 2 can be freely rotated in the second direction. In this way, damage caused to the fastener by over-rotation of the bolt 2 in the second direction can be avoided.

The spring 5 is configured to urge the hollow leg member 4 in a proximal direction with respect to the hollow tubular body 3. Further rotation of the bolt 2 in the second direction may push the hollow leg member 4 against the spring 5, compressing the spring 5 as shown. The spring 5 may maintain a contact between the thread of the bolt 2 and the thread of the hollow leg member 4. A user with a manual rotary tool may feel a clicking sensation when further rotating the bolt 2 in the second direction. In some embodiments, the spring 5 may be configured to urge the hollow leg member into a position of engagement. In the position of engagement, the threaded portion of the hollow leg member 4 may be engaged with the threaded portion of the bolt 2.

As shown, rotation of the bolt 2 in the first direction may cause the threaded portion of the hollow leg member 4 to engage with the threaded portion of the bolt 2. In this way, the spring 5 can cause immediate engagement of the threads when required. Movement of the bolt 2 with respect to the hollow tubular body 3 is not required to engage the threads. In this way, there is no movement or ‘float’ in the distal end of the bolt 2, relative to the hollow tubular body 3. As such, the fastener 10 can enable an automated system to more efficiently locate the head of the bolt 2, and engage a rotary tool to tighten the fastener 10.

FIG. 5 of the accompanying drawings shows an exemplary fastener 10 in position to clamp a workpiece with two parts, A and B. An opening is prepared through part A and part B. The hollow leg member 4 can pass through the opening, but the hollow tubular body 3 is larger than the opening.

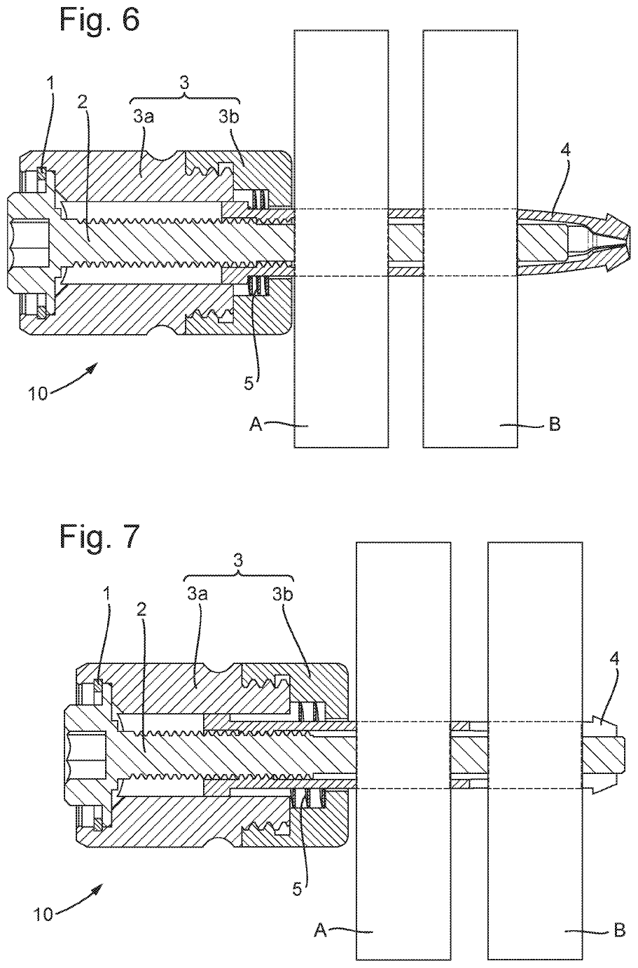

FIG. 6 of the accompanying drawings shows an exemplary fastener 10 in position and ready for clamping. The hollow leg member 4 extends through the openings in part A and part B.

As shown, the fastener is in the configuration shown in FIG. 4. The hollow leg member 4 is in the most distal position and the distal ends of the legs extend beyond the distal end of the bolt 2. Each of the resilient legs of the hollow leg member 4 is biased radially inwards towards the central axis. As shown, a portion of the resilient legs, which extends beyond the distal end of the bolt 2 may be angled or curved radially inwards. In this way, the head at the distal end of each resilient leg can pass through the openings in the work piece.

A distal face of the hollow tubular body 3 abuts with a proximal face of part A. The spring 5 urges the hollow leg member 4 in a proximal direction relative to the hollow tubular body 3. In this way, the spring 5 causes engagement of the threaded portion of the hollow leg member 4 with the threaded portion of the bolt 2. As such, there is no free movement or ‘float’ along the central axis between the threaded portions. Rotation of the bolt 2 in the first direction will immediately engage the threaded portions. In addition, there is no free movement of the bolt 2 with respect to the hollow tubular body 3. As such, an automatic system may easily locate the head of the bolt 2, and engage a rotary tool to tighten the fastener 10.

FIG. 7 of the accompanying drawings shows an exemplary fastener 10 in a partially clamped position.

As shown, the hollow leg member 4 is translated in a proximal direction relative to the bolt 2. The resilient legs of the hollow leg member 4 do not extend beyond the distal end of the bolt 2. In this position, the distal end of the bolt 2 is configured to urge the resilient legs of the hollow leg member radially outwards.

Each of the resilient legs of the hollow leg member 4 has a head at the distal end. The head may be formed as a flange portion extending radially outwards from the leg. As shown, when the resilient legs are deflected outwards by the bolt 2, the head of each leg may protrude outwards beyond the radial extent of the hollow leg member 4. The head of each leg may protrude outwards beyond the opening in part B. In this configuration, the fastener 10 cannot be withdrawn from the workpiece.

The head of each leg is configured to engage with the work-piece. For example, the head of each leg may be arranged to engage with a distal side of part B and transfer a compressive force to part B. The flange portion forming the head of each leg may include a flat surface, which is presented perpendicular to the central axis and arranged to abut with the distal face of part B.

The spring 5 causes engagement of the threaded portion of the hollow leg member 4 with the threaded portion of the bolt 2, such that rotation of the bolt 2 in the first direction will immediately engage the threaded portions. In this way, a grip range of the fastener 10 can be improved. As soon as the head of each resilient leg can engage a distal face of the work piece, each head exert a compressive force on the work piece. This compressive force can be applied from virtually the most distal position of the hollow leg member 4, as the threaded portions of the fastener 10 are engaged by the spring 5.

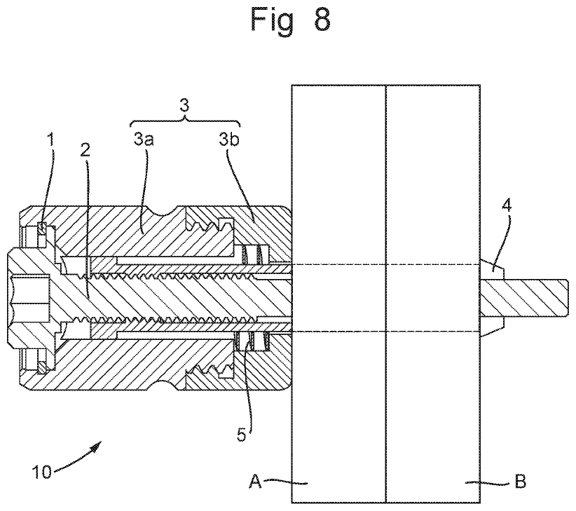

FIG. 8 of the accompanying drawings shows an exemplary fastener 10 in a fully clamped position. A compressive force is applied between a distal face of the hollow tubular body 3 and a proximally facing flat surface formed on the resilient legs of the hollow leg member 4.

Although aspects of the invention herein have been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the scope of the invention as defined by the appended claims.

### NEW EMBODIMENT

The present invention relates to a fastener. In particular, the invention relates to a single-sided temporary fastener including a free-spin feature, which can prevent damage to the fastener on removal.

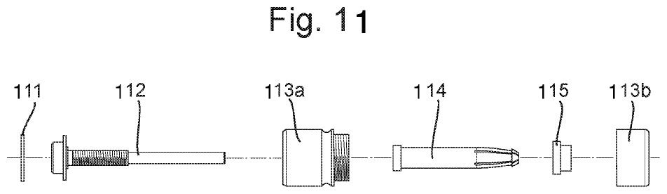

FIG. 11 of the accompanying drawings shows a fastener 110 according to a first embodiment, comprising a retaining ring 111, a bolt 112, a first hollow tubular body part 113a, a hollow leg member 114, a spacer element 115 and a second hollow tubular body part 113b. Each of the components has a central axis, about which the component is substantially symmetric. The components are configured to form the fastener 110 when assembled. In some examples, the central axis of each component is aligned when the fastener 110 is assembled. Each of the components has a distal end, defined as the end furthest from the user in normal use, and a proximal end defined as the end closest to the user in normal use. The assembled fastener 110 has a corresponding distal end and proximal end.

The retaining ring 111 has a ring shape with a central opening. In some embodiments, the retaining ring 111 may have a substantially flat profile. In some examples, the retaining ring 111 may be a stamped circlip or a spiral snap ring, e.g. a Spiralox® retaining ring.

The bolt 112 has a substantially cylindrical shape. The bolt 112 has a proximal end and a distal end. The bolt 112 comprises a threaded portion at the proximal end. In some embodiments, the bolt 112 may have an external thread. A thread of the threaded portion may extend radially outwards from a central cylindrical portion. Alternatively, the thread may be cut radially inwards into the central cylindrical portion. The threaded portion of the bolt 112 is configured to engage with a threaded portion of the hollow leg member 114.

In some embodiments, the proximal end of the bolt 112 may have a flange. The flange of the bolt 112 may be configured to engage with the first hollow tubular body part 113a to limit a position of the bolt 112.

The first hollow tubular body part 113a is configured to form a hollow tubular body 113 with the second hollow tubular body part 113b. The first hollow tubular body part 113a may be referred to as a proximal tube. The second hollow tubular body part 113b may be referred to as a cap. In some embodiments, the first hollow tubular body part 113a and second hollow tubular body part 113b may be screwed together. Alternatively, the first hollow tubular body part 113a and second hollow tubular body part 113b by a press-fit, welding, adhesive any other suitable means. In some embodiments, the hollow tubular body 113 is formed as a single piece.

The hollow tubular body 113 has a proximal end and a distal end. The proximal end may be formed by the first hollow tubular body part 113a and the distal end may be formed by the second hollow tubular body part 113b. The distal end of the hollow tubular body 113 may be a flat surface perpendicular to the central axis or may have a conical (or “countersunk”) profile. The hollow tubular body 113 has a central axis. In some embodiments, the central axis of the hollow tubular body 113 defines the central axis of the fastener 110. The hollow tubular body 113 has a central opening extending along the central axis from the proximal end to the distal end. The hollow tubular body 113 is configured to receive the retaining ring 111, the bolt 112, the hollow leg member 114 and the spacer element 115 within the central opening.

The hollow leg member 114 has a hollow, substantially cylindrical form. The hollow leg member 114 has a proximal end and a distal end. The hollow leg member 114 comprises a flange at the proximal end, a threaded portion at the proximal end and a plurality of resilient legs at the distal end. The flange extends radially outwards from the proximal end of the flange. In some embodiments, the flange of the hollow leg member 114 may include a flat surface perpendicular to the central axis of the fastener. The flat surface of the flange may face the distal direction.

Each of the resilient legs of the hollow leg member 114 has a head at the distal end. The head may be formed as a flange portion extending radially outwards from the leg. The head of each leg is configured to engage with a work-piece. For example, the head of each leg may be arranged to engage with a distal side of the work piece. As will be described later, the head may be configured to transfer a compressive force to the work piece.

In some embodiments, the resilient legs of the hollow leg member 114, may be formed to extend distally from the distal end of the hollow leg member 114. Alternatively, the legs may be formed by dividing the distal end of the hollow leg member 114. A portion of material may be removed from the hollow leg member 114 between each of the legs.

Each of the resilient legs of the hollow leg member is biased radially inwards towards the central axis. That is, the distal ends of the resilient legs may be angled or curved radially inwards towards the central axis. The resilient legs may be formed of a resilient material such that each of the legs can be deflected inwards or outwards by a deflecting force. Provided the amount of deflection does not exceed a material limit, the resilient legs may be configured to return to the original biased position if the deflecting force is removed. In some examples, the resilient legs may be biased by, for example, inward deflection of the legs beyond the material limit, or by applying heat treatment while the legs are restrained in the biased position, or by any suitable process.

In some embodiments, the spacer element 115 may have a hollow cylindrical form. The spacer element 115 has a proximal end and a distal end. In some examples, the spacer element 115 comprises a flange at the proximal end. The spacer element 115 may be configured to fit around the hollow leg member 114. The spacer element 115 may be configured to fit within the hollow tubular body 113.

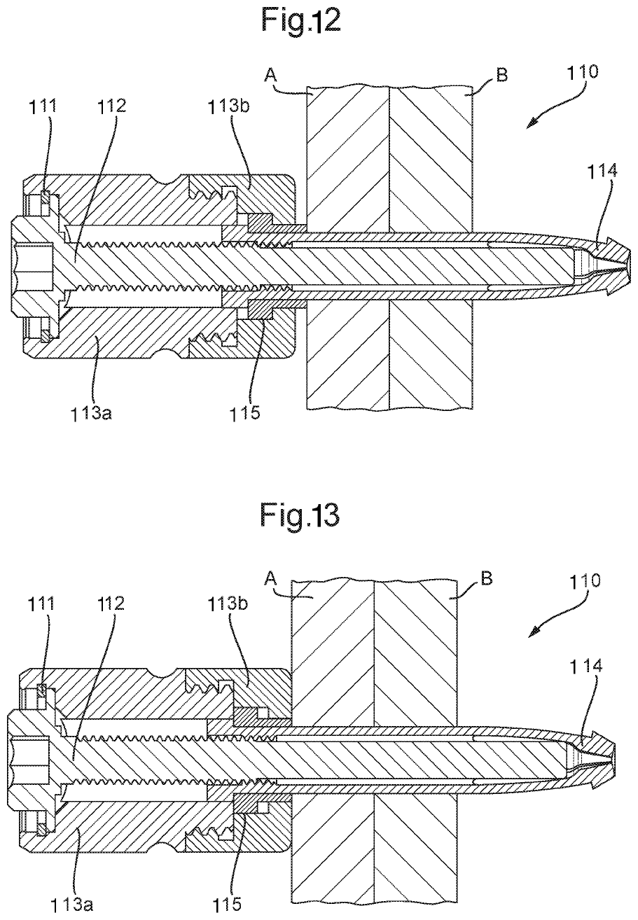

FIG. 12 of the accompanying drawings shows the fastener 110 in assembled form. As shown, the central axis of each component is aligned when the fastener 110 is assembled. The fastener 110 is shown in position to clamp a workpiece with two parts, A and B. An opening is prepared through part A and part B. The hollow leg member 114 can pass through the opening, but the hollow tubular body 113 and the spacer element 115 are larger than the opening.

As shown, the first hollow tubular body part 113a may form a hollow tubular body 113 with the second hollow tubular body part 113b. The first hollow tubular body part 113a and second hollow tubular body part 113b may be screwed together.

The hollow tubular body 113 has a proximal end and a distal end. The proximal end may be formed by the first hollow tubular body part 113a and the distal end may be formed by the second hollow tubular body part 113b. The distal end of the hollow tubular body 113 may be a flat surface perpendicular to the central axis or may have a conical (or “countersunk”) profile. The hollow tubular body 113 has a central axis. In some embodiments, the central axis of the hollow tubular body 113 defines the central axis of the fastener 110. The hollow tubular body 113 has a central opening extending along the central axis from the proximal end to the distal end. As shown, each of the retaining ring 111, the bolt 112, the hollow leg member 114 and the spacer element 115 are at least partially received within the central opening.

The bolt 112 has a substantially cylindrical form. As shown, the bolt 112 may be arranged within the central opening of the hollow tubular body 113. The bolt 112 may extend by a distance beyond the distal end of the hollow tubular body 113. In some examples, the proximal end (or “head”) of the bolt 112 may protrude from the proximal end of the hollow tubular body 113. Alternatively, the head of the bolt 112 may be within the proximal end of the central opening. The proximal end of the bolt 112 may include an engaging element configured to engage with a rotary tool. For example, the head of the bolt 112 may be formed with a polygonal, e.g. hexagonal or square, shape for engagement with a wrench, or may include a socket or recess having a shape for engagement with a socket wrench, key, or screwdriver e.g. a hexagonal, triangular, square, linear, cross or star shaped recess.

In some embodiments, the proximal end of the bolt 112 may have a flange. The flange may be formed to extend radially outwards from the cylindrical body of the bolt 112. The flange of the bolt 112 may be configured to engage with the first hollow tubular body part 113a to limit a position of the bolt 112. For example, in some embodiments, the hollow tubular body 113 may have a shoulder arranged to block the bolt 112 from moving in a distal direction. As shown, the shoulder be formed in the first hollow tubular body part 113a. The shoulder may be formed to extend radially inwards into the central opening of the hollow tubular body 113. The shoulder may be arranged to engage with the flange of the bolt 112, to fix the bolt in position with respect to the hollow tubular body 113.

In some embodiments, the hollow tubular body 113 may have a retaining means configured to engage with the flange of the bolt 112 and block the bolt 112 from moving in a proximal direction. For example, the first hollow tubular body part 113a may comprise a lip extending radially inwards into the central opening at or near the proximal end. In some embodiments, as shown, the retaining means may be provided by the retaining ring 111.

The retaining ring 111 has a ring shape with a central opening. In some embodiments, the retaining ring 111 may have a substantially flat profile. In some examples, the retaining ring 111 may be a stamped circlip or a spiral snap ring, e.g. a Spiralox retaining ring. As shown, the first hollow tubular body part 113a may comprise a retaining groove arranged to receive the retaining ring 2. The retaining groove may be positioned distally from the shoulder. The retaining ring 111 may be positioned in the retaining groove of the first hollow tubular body part 113a, and the flange of the bolt 112 may be located between the retaining ring 111 and the shoulder of the hollow tubular body 113.

The bolt 112 comprises a threaded portion at the proximal end. In some embodiments, the bolt 112 may have an external thread. A thread of the threaded portion may extend radially outwards from a central cylindrical portion. Alternatively, the thread may be cut radially inwards into the central cylindrical portion. The threaded portion of the bolt 112 is configured to engage with a threaded portion of the hollow leg member 114.

The hollow leg member 114 has a hollow, substantially cylindrical form. The hollow leg member comprises a plurality of resilient legs at the distal end. In some embodiments, the resilient legs of the hollow leg member 114, may be formed to extend distally from the distal end of the hollow leg member 114. Alternatively, the legs may be formed by dividing the distal end of the hollow leg member 114. A portion of material may be removed from the hollow leg member 114 between each of the legs.

As shown, the hollow leg member 114 may be arranged within the central opening of the hollow tubular body 113. The hollow leg member 114 may extend by a distance beyond the distal end of the hollow tubular body 113. The hollow leg member is translatable within the hollow tubular body 113 along the central axis of the hollow tubular body 113.

The hollow leg member 114 comprises a flange at the proximal end. The flange extends radially outwards from the proximal end of the flange. In some embodiments, the flange of the hollow leg member 114 may include a flat surface perpendicular to the central axis of the fastener. The flat surface of the flange may face the distal direction.

The hollow tubular body 113 comprises a stop portion extending radially inwards at the distal end. For example, the second hollow tubular body part 113b may be formed with a lip extending radially inwards into the central opening of the hollow tubular body 113. In some embodiments, the stop portion of the hollow tubular body 113 may have a flat surface perpendicular to the central axis of the fastener. The flat surface of the stop portion may face the proximal direction.

The spacer element 115 may be arranged to abut with the flange of the hollow leg member 114. The spacer element 115 may be configured to fit around a cylindrical portion of the hollow leg member 114 and abut with the distally facing flat surface of the flange. The proximal end of spacer element 115 may include a corresponding flat surface perpendicular to the central axis of the fastener. The distal end of the spacer element 115 may extend distally out of the hollow tubular body 113. A distal surface of the spacer element 115 may be an example of an engaging surface.

The engaging surface extends perpendicular to the central axis of the fastener 110. The engaging surface is arranged distally of the hollow tubular body 113 to engage with a proximal face of the work piece A. The engaging surface is configured, when the engaging surface is urged against the proximal face of the work piece A, to urge the hollow leg member 114 into a position of engagement in which the threaded portion of the hollow leg member 114 is engaged with the threaded portion of the bolt 112.

Each of the resilient legs of the hollow leg member 114 is biased radially inwards towards the central axis. That is, the distal ends of the resilient legs may be angled or curved radially inwards towards the central axis. In some examples, the resilient legs may be biased by, for example, inward deflection of the legs beyond the material limit, or by applying heat treatment while the legs are restrained in the biased position, or by any suitable process. As shown, a portion of the resilient legs, which extends beyond the distal end of the bolt 112 may be angled or curved radially inwards.

The hollow leg member 114 is in the most distal position and the distal ends of the legs extend beyond the distal end of the bolt 112. Each of the resilient legs of the hollow leg member 114 is biased radially inwards towards the central axis. As shown, a portion of the resilient legs, which extends beyond the distal end of the bolt 112 may be angled or curved radially inwards. In this way, the head at the distal end of each resilient leg can pass through the openings in the work piece.

The hollow leg member 114 comprises a threaded portion at the proximal end. In some embodiments, the hollow leg member 114 may have an internal thread. For example, the hollow leg member 114 may include a thread extending radially inwards from an inner wall of the hollow cylindrical form. Alternatively, the thread may be cut radially outwards into the inner wall of the hollow cylindrical form.

The threaded portion of the bolt 112 is configured to engage with a threaded portion of the hollow leg member 114. In this way, rotation of the bolt 112 in a first direction draws the hollow leg member 114 in a proximal direction along the central axis. The first direction may be referred to as a fastening, tightening or clamping direction. In some examples, the first direction may be clockwise from the perspective of the user. Alternatively, the first direction may be anti-clockwise. By rotation of the bolt 112 in the first direction, the hollow leg member 114 may be translated in a proximal direction relative to the bolt 112. The hollow leg member 114 may also be translated in a proximal direction relative to the hollow tubular body 113. In some examples, the hollow leg member 114 may be drawn further within the central opening of the hollow tubular body 113. In some examples, the resilient legs of the hollow leg member 114 may be moved in a proximal direction towards or past the distal end of the hollow tubular body 113.

Rotation of the bolt 112 in a second direction opposite to the first direction is configured to translate the hollow leg member 114 in a distal direction along the central axis. The second direction may be referred to as an unfastening, loosening or detaching direction. In some examples, where the first direction is clockwise from the perspective of the user, the second direction may be anti-clockwise and vice versa. By rotation of the bolt 112 in the second direction, the hollow leg member 114 may be translated in a distal direction relative to the bolt 112. The hollow leg member 114 may also be translated in a distal direction relative to the hollow tubular body 113. In some examples, the hollow leg member 114 may be pushed further out of the central opening of the hollow tubular body 113. In some examples, the resilient legs of the hollow leg member 114 may be moved in a distal direction away from the distal end of the hollow tubular body 113.

The fastener 110 is shown after rotation of the bolt 112 in the second direction. As shown, the hollow leg member 114 is translated in a distal direction relative to the bolt 112. The resilient legs of the hollow leg member 114 extend beyond the distal end of the bolt 112. In this position, the distal end of the bolt 112 does not urge the resilient legs of the hollow leg member radially outwards. In some embodiments, the resilient legs may be formed of a resilient material such that each of the legs can be deflected inwards or outwards by a deflecting force. Provided the amount of deflection caused by the bolt 112 has not exceeded a material limit, the resilient legs may be configured to return to the original biased position when the bolt 112 is removed.

Rotation in the second direction causes the threaded portion of the hollow leg member 114 to disengage from the threaded portion of the bolt 112. As the threaded portion of the bolt 112 is at the proximal end of the bolt 112, the threaded portion of the hollow leg member 114 may be translated distally out of the threaded portion of the bolt 112. In this way, the threaded portion of the hollow leg member 114 can be disengaged from the threaded portion of the bolt 112. In this configuration, the bolt 112 can be freely rotated in the second direction. In this way, damage caused to the fastener by over-rotation of the bolt 112 in the second direction can be avoided.

The proximal end of the spacer element may include a flange. The stop portion arranged of the hollow tubular body 113 may be arranged to engage with the flange of the spacer element 115 and block the spacer element 115 from moving in a distal direction.

In this way, the spacer element 115 and/or the stop portion of the hollow tubular body 113 may be configured to block the hollow leg member 114 from moving in the distal direction. In some embodiments, the distal ends of the legs may extend beyond the distal end of the bolt 112 when the hollow leg member 114 is in the most distal position, as shown in FIG. 2.

FIG. 13 of the accompanying drawings shows the fastener 110 in position and ready for clamping. The hollow leg member 114 extends through the openings in part A and part B.

As shown, the fastener 110 is urged against the proximal face of part A until a distal face of the hollow tubular body 113 abuts with the proximal face of part A. The spacer element 115 urges the hollow leg member 114 in a proximal direction relative to the hollow tubular body 113. When the engaging surface of the spacer element 115 is urged against the proximal face of the work piece, the spacer element 115 may be configured to exert a force on the distally facing flat surface of the hollow leg member 114. When the spacer element is urged against the proximal face of the work piece, the proximal end of the spacer element may urge the hollow leg member into the position of engagement.

In this way, the spacer element 115 causes engagement of the threaded portion of the hollow leg member 114 with the threaded portion of the bolt 112. As such, there is no free movement or ‘float’ along the central axis between the threaded portions. Rotation of the bolt 112 in the first direction will immediately engage the threaded portions. In addition, there is no free movement of the bolt 112 with respect to the hollow tubular body 113. As such, an automatic system may easily locate the head of the bolt 112, and engage a rotary tool to tighten the fastener 110.

In the position of engagement shown, rotation of the bolt 112 in the first direction may cause the threaded portion of the hollow leg member 114 to engage with the threaded portion of the bolt 112. In this way, the spacer element 115 can cause immediate engagement of the threads when required. Movement of the bolt 112 with respect to the hollow tubular body 113 is not required to engage the threads. In this way, there is no movement or ‘float’ in the distal end of the bolt 112, relative to the hollow tubular body 113. As such, the fastener 110 can enable an automated system to more efficiently locate the head of the bolt 112, and engage a rotary tool to tighten the fastener 110.

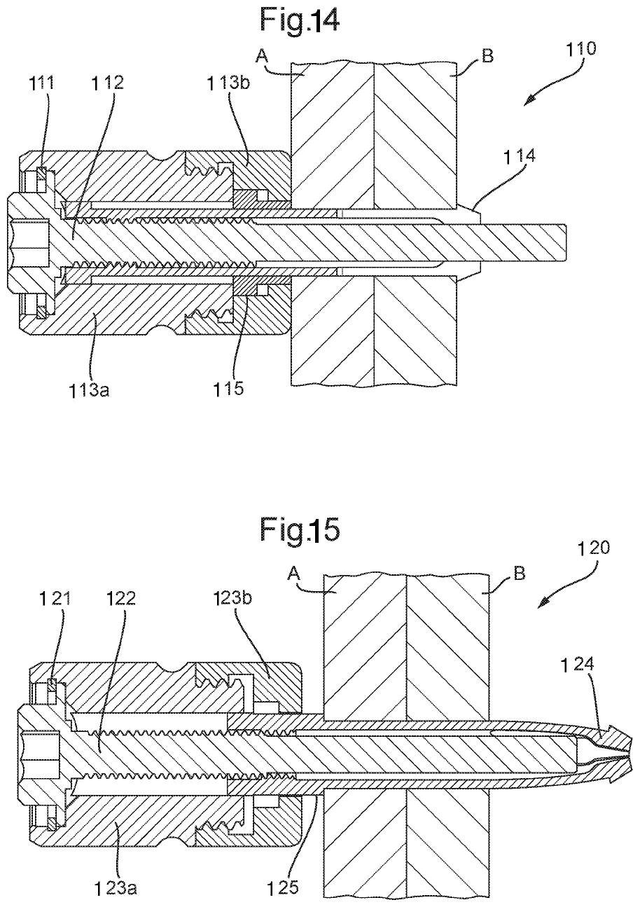

FIG. 14 of the accompanying drawings shows the fastener 110 after rotation of the bolt 112 in the first direction. The fastener 110 is shown in a fully clamped position. A compressive force is applied between a distal face of the hollow tubular body 113 and a proximally facing flat surface formed on the resilient legs of the hollow leg member 114. As shown, the hollow leg member 114 is translated in a proximal direction relative to the bolt 112. The resilient legs of the hollow leg member 114 do not extend beyond the distal end of the bolt 112. In this position, the distal end of the bolt 112 is configured to urge the resilient legs of the hollow leg member radially outwards.

In some embodiments, the resilient legs may be formed of a resilient material such that each of the legs can be deflected inwards or outwards by a deflecting force, e.g. by the bolt 112. Provided the amount of deflection does not exceed a material limit, the resilient legs may be configured to return to the original biased position if the deflecting force is removed.

Each of the resilient legs of the hollow leg member 114 has a head at the distal end. The head may be formed as a flange portion extending radially outwards from the leg. As shown, when the resilient legs are deflected outwards by the bolt 112, the head of each leg may protrude outwards beyond the radial extent of the hollow leg member 114. The head of each leg may protrude outwards beyond the opening in part B. In this configuration, the fastener 110 cannot be withdrawn from the workpiece.

The head of each leg is configured to engage with the work-piece. For example, the head of each leg may be arranged to engage with a distal side of part B and transfer a compressive force to part B. The flange portion forming the head of each leg may include a flat surface, which is presented perpendicular to the central axis and arranged to abut with the distal face of part B.

As described above, the action of the spacer element 115 causes engagement of the threaded portion of the hollow leg member 114 with the threaded portion of the bolt 112, such that rotation of the bolt 112 in the first direction will immediately engage the threaded portions. In this way, a grip range of the fastener 110 can be improved. As soon as the head of each resilient leg can engage a distal face of the work piece, each head exert a compressive force on the work piece. This compressive force can be applied from virtually the most distal position of the hollow leg member 114, as the threaded portions of the fastener 110 are engaged by the action of the spacer element 115.

FIG. 15 of the accompanying drawings shows the fastener 120 according to a second embodiment. Elements not described are substantially as described with respect to the first embodiment. The fastener 120 is shown in assembled form. As shown, the central axis of each component is aligned when the fastener 120 is assembled. The fastener 120 is shown in position to clamp a workpiece with two parts, A and B. An opening is prepared through part A and part B. The hollow leg member 124 can pass through the opening, but the hollow tubular body 123 and a proximal end of the hollow leg member 124 are larger than the opening.

As shown, the first hollow tubular body part 123a may form a hollow tubular body 123 with the second hollow tubular body part 123b. The first hollow tubular body part 123a and second hollow tubular body part 123b may be screwed together.

The hollow tubular body 123 has a proximal end and a distal end. The proximal end may be formed by the first hollow tubular body part 123a and the distal end may be formed by the second hollow tubular body part 123b. The distal end of the hollow tubular body 123 may be a flat surface perpendicular to the central axis or may have a conical (or “countersunk”) profile. The hollow tubular body 123 has a central axis. In some embodiments, the central axis of the hollow tubular body 123 defines the central axis of the fastener 20. The hollow tubular body 123 has a central opening extending along the central axis from the proximal end to the distal end. As shown, each of the retaining ring 121, the bolt 122, and the hollow leg member 124 are at least partially received within the central opening.

The bolt 122 has a substantially cylindrical form. As shown, the bolt 122 may be arranged within the central opening of the hollow tubular body 123. The bolt 122 may extend by a distance beyond the distal end of the hollow tubular body 123. In some examples, the proximal end (or “head”) of the bolt 122 may protrude from the proximal end of the hollow tubular body 123. Alternatively, the head of the bolt 122 may be within the proximal end of the central opening. The proximal end of the bolt 122 may include an engaging element configured to engage with a rotary tool. For example, the head of the bolt 122 may be formed with a polygonal, e.g. hexagonal or square, shape for engagement with a wrench, or may include a socket or recess having a shape for engagement with a socket wrench, key, or screwdriver e.g. a hexagonal, triangular, square, linear, cross or star shaped recess.

In some embodiments, the proximal end of the bolt 122 may have a flange. The flange may be formed to extend radially outwards from the cylindrical body of the bolt 122. The flange of the bolt 122 may be configured to engage with the first hollow tubular body part 123a to limit a position of the bolt 122. For example, in some embodiments, the hollow tubular body 123 may have a shoulder arranged to block the bolt 122 from moving in a distal direction. As shown, the shoulder be formed in the first hollow tubular body part 123a. The shoulder may be formed to extend radially inwards into the central opening of the hollow tubular body 123. The shoulder may be arranged to engage with the flange of the bolt 122, to fix the bolt in position with respect to the hollow tubular body 123.

In some embodiments, the hollow tubular body 123 may have a retaining means configured to engage with the flange of the bolt 122 and block the bolt 122 from moving in a proximal direction. For example, the first hollow tubular body part 123a may comprise a lip extending radially inwards into the central opening at or near the proximal end. In some embodiments, as shown, the retaining means may be provided by the retaining ring 121.

The retaining ring 121 has a ring shape with a central opening. In some embodiments, the retaining ring 121 may have a substantially flat profile. In some examples, the retaining ring 121 may be a stamped circlip or a spiral snap ring, e.g. a Spiralox retaining ring. As shown, the first hollow tubular body part 123a may comprise a retaining groove arranged to receive the retaining ring 12. The retaining groove may be positioned distally from the shoulder. The retaining ring 121 may be positioned in the retaining groove of the first hollow tubular body part 213a, and the flange of the bolt 122 may be located between the retaining ring 121 and the shoulder of the hollow tubular body 123.

The bolt 122 comprises a threaded portion at the proximal end. In some embodiments, the bolt 122 may have an external thread. A thread of the threaded portion may extend radially outwards from a central cylindrical portion. Alternatively, the thread may be cut radially inwards into the central cylindrical portion. The threaded portion of the bolt 122 is configured to engage with a threaded portion of the hollow leg member 124.

The hollow leg member 124 has a hollow, substantially cylindrical form. The hollow leg member comprises a plurality of resilient legs at the distal end. In some embodiments, the resilient legs of the hollow leg member 124, may be formed to extend distally from the distal end of the hollow leg member 124. Alternatively, the legs may be formed by dividing the distal end of the hollow leg member 124. A portion of material may be removed from the hollow leg member 124 between each of the legs.

As shown, the hollow leg member 124 may be arranged within the central opening of the hollow tubular body 123. The hollow leg member 124 may extend by a distance beyond the distal end of the hollow tubular body 123. The hollow leg member is translatable within the hollow tubular body 123 along the central axis of the hollow tubular body 123.

The hollow leg member 124 may have a step profile 125. The step profile 125 of the hollow leg member 124 may have a larger diameter at the proximal end. In some examples, the step profile 125 may include a flat step surface perpendicular to the central axis of the fastener. The flat step surface of the step profile 125 may face the distal direction. The flat step surface of the step profile 125 may be an example of an engaging surface.

The engaging surface extends perpendicular to the central axis of the fastener 120. The step profile 125 may be formed at a point on the hollow leg member 124 such that the step profile 125 is arranged distally of the hollow tubular body 123 when the hollow leg member 124 is in the most distal position. The engaging surface is arranged distally of the hollow tubular body 123 to engage with a proximal face of the work piece A. The engaging surface is configured, when the engaging surface is urged against the proximal face of the work piece A, to urge the hollow leg member 124 into a position of engagement in which the threaded portion of the hollow leg member 124 is engaged with the threaded portion of the bolt 122.

In some examples, the step profile 125 of the hollow leg member 124 may be referred to as a flange. In some examples, the hollow leg member 124 may also include a flange at the proximal end (not shown), substantially as described with respect to the first embodiment. The stop portion arranged of the hollow tubular body 123 may be arranged to engage with the flange of the hollow leg member 124 and block the hollow leg member 124 from moving in a distal direction.

Each of the resilient legs of the hollow leg member 124 is biased radially inwards towards the central axis. That is, the distal ends of the resilient legs may be angled or curved radially inwards towards the central axis. In some examples, the resilient legs may be biased by, for example, inward deflection of the legs beyond the material limit, or by applying heat treatment while the legs are restrained in the biased position, or by any suitable process. As shown, a portion of the resilient legs, which extends beyond the distal end of the bolt 122 may be angled or curved radially inwards.

The hollow leg member 124 is in the most distal position and the distal ends of the legs extend beyond the distal end of the bolt 122. Each of the resilient legs of the hollow leg member 124 is biased radially inwards towards the central axis. As shown, a portion of the resilient legs, which extends beyond the distal end of the bolt 122 may be angled or curved radially inwards. In this way, the head at the distal end of each resilient leg can pass through the openings in the work piece.

The hollow leg member 124 comprises a threaded portion at the proximal end. In some embodiments, the hollow leg member 124 may have an internal thread. For example, the hollow leg member 124 may include a thread extending radially inwards from an inner wall of the hollow cylindrical form. Alternatively, the thread may be cut radially outwards into the inner wall of the hollow cylindrical form.

The threaded portion of the bolt 122 is configured to engage with a threaded portion of the hollow leg member 124. In this way, rotation of the bolt 122 in a first direction draws the hollow leg member 124 in a proximal direction along the central axis. The first direction may be referred to as a fastening, tightening or clamping direction. In some examples, the first direction may be clockwise from the perspective of the user. Alternatively, the first direction may be anti-clockwise. By rotation of the bolt 122 in the first direction, the hollow leg member 124 may be translated in a proximal direction relative to the bolt 122. The hollow leg member 124 may also be translated in a proximal direction relative to the hollow tubular body 123. In some examples, the hollow leg member 124 may be drawn further within the central opening of the hollow tubular body 123. In some examples, the resilient legs of the hollow leg member 124 may be moved in a proximal direction towards or past the distal end of the hollow tubular body 123.

Rotation of the bolt 122 in a second direction opposite to the first direction is configured to translate the hollow leg member 124 in a distal direction along the central axis. The second direction may be referred to as an unfastening, loosening or detaching direction. In some examples, where the first direction is clockwise from the perspective of the user, the second direction may be anti-clockwise and vice versa. By rotation of the bolt 122 in the second direction, the hollow leg member 124 may be translated in a distal direction relative to the bolt 122. The hollow leg member 124 may also be translated in a distal direction relative to the hollow tubular body 123. In some examples, the hollow leg member 124 may be pushed further out of the central opening of the hollow tubular body 123. In some examples, the resilient legs of the hollow leg member 124 may be moved in a distal direction away from the distal end of the hollow tubular body 123.

The fastener 120 is shown after rotation of the bolt 122 in the second direction. As shown, the hollow leg member 124 is translated in a distal direction relative to the bolt 122. In this position, the step profile 125 is arranged distally of the hollow tubular body 123. The resilient legs of the hollow leg member 124 extend beyond the distal end of the bolt 122. In this position, the distal end of the bolt 122 does not urge the resilient legs of the hollow leg member radially outwards. In some embodiments, the resilient legs may be formed of a resilient material such that each of the legs can be deflected inwards or outwards by a deflecting force. Provided the amount of deflection caused by the bolt 122 has not exceeded a material limit, the resilient legs may be configured to return to the original biased position when the bolt 122 is removed.

Rotation in the second direction causes the threaded portion of the hollow leg member 124 to disengage from the threaded portion of the bolt 122. As the threaded portion of the bolt 122 is at the proximal end of the bolt 122, the threaded portion of the hollow leg member 124 may be translated distally out of the threaded portion of the bolt 122. In this way, the threaded portion of the hollow leg member 124 can be disengaged from the threaded portion of the bolt 122. In this configuration, the bolt 122 can be freely rotated in the second direction. In this way, damage caused to the fastener by over-rotation of the bolt 122 in the second direction can be avoided.

FIG. 16 of the accompanying drawings shows the fastener 120 in position and ready for clamping. The hollow leg member 124 extends through the openings in part A and part B.

As shown, the fastener 120 is urged against the proximal face of part A until a distal face of the hollow tubular body 123 abuts with the proximal face of part A. The step profile 125 urges the hollow leg member 124 in a proximal direction relative to the hollow tubular body 123. When the engaging surface of the step profile 125 is urged against the proximal face of the work piece A, the hollow leg member 124 may be moved into the position of engagement.

In this way, the step profile 125 causes engagement of the threaded portion of the hollow leg member 124 with the threaded portion of the bolt 122. As such, there is no free movement or ‘float’ along the central axis between the threaded portions. Rotation of the bolt 122 in the first direction will immediately engage the threaded portions. In addition, there is no free movement of the bolt 122 with respect to the hollow tubular body 123. As such, an automatic system may easily locate the head of the bolt 122, and engage a rotary tool to tighten the fastener 120.

In the position of engagement shown, rotation of the bolt 122 in the first direction may cause the threaded portion of the hollow leg member 124 to engage with the threaded portion of the bolt 122. In this way, the step profile 125 can cause immediate engagement of the threads when required. Movement of the bolt 122 with respect to the hollow tubular body 123 is not required to engage the threads. In this way, there is no movement or ‘float’ in the distal end of the bolt 122, relative to the hollow tubular body 123. As such, the fastener 120 can enable an automated system to more efficiently locate the head of the bolt 122, and engage a rotary tool to tighten the fastener 120.

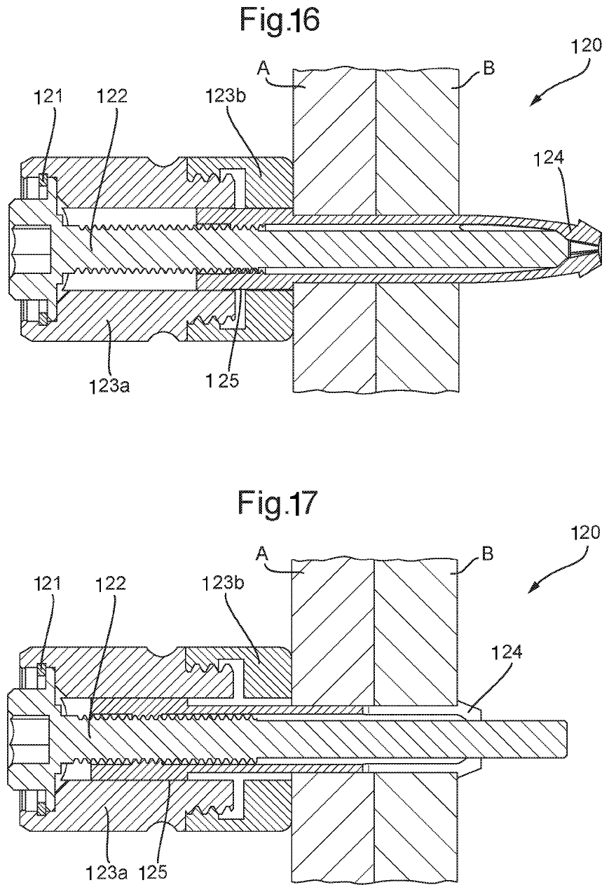

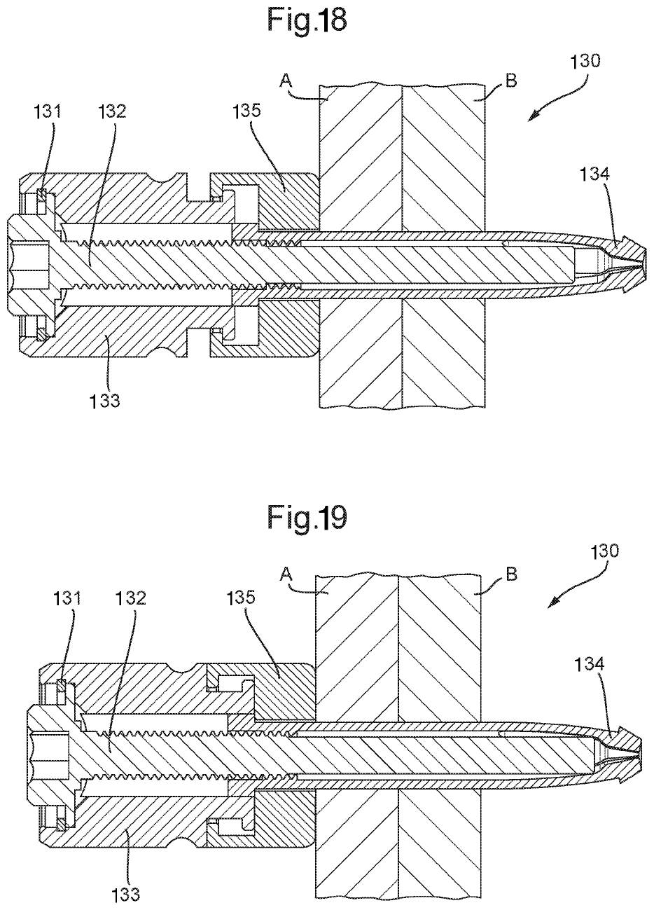

FIG. 17 of the accompanying drawings shows the fastener 120 after rotation of the bolt 122 in the first direction. The fastener 120 is shown in a fully clamped position. A compressive force is applied between a distal face of the hollow tubular body 123 and a proximally facing flat surface formed on the resilient legs of the hollow leg member 124.

As shown, the hollow leg member 124 is translated in a proximal direction relative to the bolt 122. The resilient legs of the hollow leg member 124 do not extend beyond the distal end of the bolt 122. In this position, the distal end of the bolt 122 is configured to urge the resilient legs of the hollow leg member radially outwards.

In some embodiments, the resilient legs may be formed of a resilient material such that each of the legs can be deflected inwards or outwards by a deflecting force, e.g. by the bolt 122. Provided the amount of deflection does not exceed a material limit, the resilient legs may be configured to return to the original biased position if the deflecting force is removed.

Each of the resilient legs of the hollow leg member 124 has a head at the distal end. The head may be formed as a flange portion extending radially outwards from the leg. As shown, when the resilient legs are deflected outwards by the bolt 122, the head of each leg may protrude outwards beyond the radial extent of the hollow leg member 124. The head of each leg may protrude outwards beyond the opening in part B. In this configuration, the fastener 120 cannot be withdrawn from the workpiece.

The head of each leg is configured to engage with the work-piece. For example, the head of each leg may be arranged to engage with a distal side of part B and transfer a compressive force to part B. The flange portion forming the head of each leg may include a flat surface, which is presented perpendicular to the central axis and arranged to abut with the distal face of part B.

As described above, the action of the step profile 125 causes engagement of the threaded portion of the hollow leg member 124 with the threaded portion of the bolt 122, such that rotation of the bolt 122 in the first direction will immediately engage the threaded portions. In this way, a grip range of the fastener 120 can be improved. As soon as the head of each resilient leg can engage a distal face of the work piece, each head exert a compressive force on the work piece. This compressive force can be applied from virtually the most distal position of the hollow leg member 124, as the threaded portions of the fastener 120 are engaged by action of the step profile 125.

FIG. 18 of the accompanying drawings shows the fastener 130 according to a third embodiment. Elements not described are substantially as described with respect to the first embodiment. The fastener 130 is shown in assembled form. As shown, the central axis of each component is aligned when the fastener 130 is assembled. The fastener 130 is shown in position to clamp a workpiece with two parts, A and B. An opening is prepared through part A and part B. The hollow leg member 134 can pass through the opening, but the spacer element 135 is larger than the opening.

As shown, the fastener 130 may comprise a hollow tubular body 133 formed as a single piece. The hollow tubular body 133 has a proximal end and a distal end. The hollow tubular body 133 has a central axis. In some embodiments, the central axis of the hollow tubular body 133 defines the central axis of the fastener 130. The hollow tubular body 133 has a central opening extending along the central axis from the proximal end to the distal end. As shown, each of the retaining ring 131, the bolt 132 and the hollow leg member 134 are at least partially received within the central opening.

The bolt 132 has a substantially cylindrical form. As shown, the bolt 132 may be arranged within the central opening of the hollow tubular body 133. The bolt 132 may extend by a distance beyond the distal end of the hollow tubular body 133. In some examples, the proximal end (or “head”) of the bolt 132 may protrude from the proximal end of the hollow tubular body 133. Alternatively, the head of the bolt 132 may be within the proximal end of the central opening. The proximal end of the bolt 132 may include an engaging element configured to engage with a rotary tool. For example, the head of the bolt 132 may be formed with a polygonal, e.g. hexagonal or square, shape for engagement with a wrench, or may include a socket or recess having a shape for engagement with a socket wrench, key, or screwdriver e.g. a hexagonal, triangular, square, linear, cross or star shaped recess.

In some embodiments, the proximal end of the bolt 132 may have a flange. The flange may be formed to extend radially outwards from the cylindrical body of the bolt 132. The flange of the bolt 132 may be configured to engage with the hollow tubular body 133 to limit a position of the bolt 132. For example, in some embodiments, the hollow tubular body 133 may have a shoulder arranged to block the bolt 132 from moving in a distal direction. The shoulder may be formed to extend radially inwards into the central opening of the hollow tubular body 133. The shoulder may be arranged to engage with the flange of the bolt 132, to fix the bolt in position with respect to the hollow tubular body 133.

In some embodiments, the hollow tubular body 133 may have a retaining means configured to engage with the flange of the bolt 132 and block the bolt 132 from moving in a proximal direction. For example, the hollow tubular body 133 may comprise a lip extending radially inwards into the central opening at or near the proximal end. In some embodiments, as shown, the retaining means may be provided by the retaining ring 131.

The retaining ring 131 has a ring shape with a central opening. In some embodiments, the retaining ring 131 may have a substantially flat profile. In some examples, the retaining ring 131 may be a stamped circlip or a spiral snap ring, e.g. a spiralox retaining ring. As shown, the hollow tubular body 133 may comprise a retaining groove arranged to receive the retaining ring 2. The retaining groove may be positioned distally from the shoulder. The retaining ring 131 may be positioned in the retaining groove of the hollow tubular body 133, and the flange of the bolt 132 may be located between the retaining ring 131 and the shoulder of the hollow tubular body 133.

The bolt 132 comprises a threaded portion at the proximal end. In some embodiments, the bolt 132 may have an external thread. A thread of the threaded portion may extend radially outwards from a central cylindrical portion. Alternatively, the thread may be cut radially inwards into the central cylindrical portion. The threaded portion of the bolt 132 is configured to engage with a threaded portion of the hollow leg member 134.

The hollow leg member 134 has a hollow, substantially cylindrical form. The hollow leg member comprises a plurality of resilient legs at the distal end. In some embodiments, the resilient legs of the hollow leg member 134, may be formed to extend distally from the distal end of the hollow leg member 134. Alternatively, the legs may be formed by dividing the distal end of the hollow leg member 134. A portion of material may be removed from the hollow leg member 134 between each of the legs.

As shown, the hollow leg member 134 may be arranged within the central opening of the hollow tubular body 133. The hollow leg member 134 may extend by a distance beyond the distal end of the hollow tubular body 133. The hollow leg member is translatable within the hollow tubular body 133 along the central axis of the hollow tubular body 133.

The hollow leg member 134 comprises a flange at the proximal end. The flange extends radially outwards from the proximal end of the flange. In some embodiments, the flange of the hollow leg member 134 may include a flat surface perpendicular to the central axis of the fastener. The flat surface of the flange may face the distal direction.

In some embodiments, the spacer element 135 may have a hollow cylindrical form. The spacer element 135 has a proximal end and a distal end. The spacer element 135 may be configured to fit around the hollow leg member 134. The spacer element 135 may be arranged distally of the hollow tubular body 133. At least a portion of the spacer element 25 may be configured to fit around the hollow tubular body 133. For example, the proximal end of the spacer element 135 may include a sleeve portion arranged to fit around the distal end of the hollow tubular body 133. The spacer element 135 is translatable along the central axis with respect to the hollow tubular body 133. For example, the hollow tubular body 133 is translatable along the central axis within the sleeve portion of the spacer element 133.

The spacer element 135 may be arranged to abut with the flange of the hollow leg member 134. The spacer element 135 may be configured to fit around a cylindrical portion of the hollow leg member 134 and abut with the distally facing flat surface of the flange. The spacer element 135 may include a corresponding flat surface perpendicular to the central axis of the fastener 130. The corresponding flat surface of the spacer element 135 may be arranged within the sleeve portion of the spacer element 135. A distal surface of the spacer element 135 may be an example of an engaging surface. The distal end of the spacer element 135 may be a flat surface perpendicular to the central axis or may have a conical (or “countersunk”) profile.

The engaging surface extends perpendicular to the central axis of the fastener 130. The engaging surface is arranged distally of the hollow tubular body 133 to engage with a proximal face of the work piece A. The engaging surface is configured, when the engaging surface is urged against the proximal face of the work piece A, to urge the hollow leg member 134 into a position of engagement in which the threaded portion of the hollow leg member 134 is engaged with the threaded portion of the bolt 132.

The hollow tubular body 133 may comprises a stop portion extending radially outwards at the distal end. For example, the hollow tubular body 133 may be formed with a lip extending radially outwards at the distal end. In some embodiments, the stop portion of the hollow tubular body 133 may have a flat surface perpendicular to the central axis of the fastener. The flat surface of the stop portion may face the proximal direction.

The proximal end of the spacer element 135 may include a flange. The flange of the spacer element 135 may extend radially inwards from the proximal end. For example, the flange may extend inwards from the sleeve portion of the spacer element 135. The stop portion of the hollow tubular body 133 may be arranged to engage with the flange of the spacer element 135 and block the spacer element 135 from moving in a distal direction.

In this way, the spacer element 135 and/or the stop portion of the hollow tubular body 133 may be configured to block the hollow leg member 134 from moving in the distal direction.

Each of the resilient legs of the hollow leg member 134 is biased radially inwards towards the central axis. That is, the distal ends of the resilient legs may be angled or curved radially inwards towards the central axis. In some examples, the resilient legs may be biased by, for example, inward deflection of the legs beyond the material limit, or by applying heat treatment while the legs are restrained in the biased position, or by any suitable process. As shown, a portion of the resilient legs, which extends beyond the distal end of the bolt 132 may be angled or curved radially inwards.

In some embodiments, the distal ends of the legs may extend beyond the distal end of the bolt 132 when the hollow leg member 134 is in the most distal position, as shown. Each of the resilient legs of the hollow leg member 134 is biased radially inwards towards the central axis. As shown, a portion of the resilient legs, which extends beyond the distal end of the bolt 132 may be angled or curved radially inwards. In this way, the head at the distal end of each resilient leg can pass through the openings in the work piece.

The hollow leg member 134 comprises a threaded portion at the proximal end. In some embodiments, the hollow leg member 134 may have an internal thread. For example, the hollow leg member 134 may include a thread extending radially inwards from an inner wall of the hollow cylindrical form. Alternatively, the thread may be cut radially outwards into the inner wall of the hollow cylindrical form.

The threaded portion of the bolt 132 is configured to engage with a threaded portion of the hollow leg member 134. In this way, rotation of the bolt 132 in a first direction draws the hollow leg member 134 in a proximal direction along the central axis. The first direction may be referred to as a fastening, tightening or clamping direction. In some examples, the first direction may be clockwise from the perspective of the user. Alternatively, the first direction may be anti-clockwise. By rotation of the bolt 132 in the first direction, the hollow leg member 134 may be translated in a proximal direction relative to the bolt 132. The hollow leg member 134 may also be translated in a proximal direction relative to the hollow tubular body 133. In some examples, the hollow leg member 134 may be drawn further within the central opening of the hollow tubular body 133. In some examples, the resilient legs of the hollow leg member 134 may be moved in a proximal direction towards or past the distal end of the hollow tubular body 133.

Rotation of the bolt 132 in a second direction opposite to the first direction is configured to translate the hollow leg member 134 in a distal direction along the central axis. The second direction may be referred to as an unfastening, loosening or detaching direction. In some examples, where the first direction is clockwise from the perspective of the user, the second direction may be anti-clockwise and vice versa. By rotation of the bolt 132 in the second direction, the hollow leg member 134 may be translated in a distal direction relative to the bolt 132. The hollow leg member 134 may also be translated in a distal direction relative to the hollow tubular body 133. In some examples, the hollow leg member 134 may be pushed further out of the central opening of the hollow tubular body 133. In some examples, the resilient legs of the hollow leg member 134 may be moved in a distal direction away from the distal end of the hollow tubular body 133.

The fastener 130 is shown after rotation of the bolt 132 in the second direction. As shown, the hollow leg member 134 is translated in a distal direction relative to the bolt 132. The resilient legs of the hollow leg member 134 extend beyond the distal end of the bolt 132. In this position, the distal end of the bolt 132 does not urge the resilient legs of the hollow leg member radially outwards. In some embodiments, the resilient legs may be formed of a resilient material such that each of the legs can be deflected inwards or outwards by a deflecting force. Provided the amount of deflection caused by the bolt 132 has not exceeded a material limit, the resilient legs may be configured to return to the original biased position when the bolt 132 is removed.

Rotation in the second direction causes the threaded portion of the hollow leg member 134 to disengage from the threaded portion of the bolt 132. As the threaded portion of the bolt 132 is at the proximal end of the bolt 132, the threaded portion of the hollow leg member 134 may be translated distally out of the threaded portion of the bolt 132. In this way, the threaded portion of the hollow leg member 134 can be disengaged from the threaded portion of the bolt 132. In this configuration, the bolt 132 can be freely rotated in the second direction. In this way, damage caused to the fastener by over-rotation of the bolt 132 in the second direction can be avoided.

FIG. 9 of the accompanying drawings shows fastener 130 in position and ready for clamping. The hollow leg member 134 extends through the openings in part A and part B.

As shown, the fastener 130 is urged against the proximal face of part A. For example, the distal face of the spacer element 135 is urged against the proximal face of part A. The hollow tubular body 133 is urged distally and is translated distally relative to the spacer element 135. The spacer element 135 urges the hollow leg member 134 in a proximal direction relative to the hollow tubular body 133. When the engaging surface of the spacer element 135 is urged against the proximal face of the work piece A, the spacer element 135 may be configured to exert a force on the distally facing flat surface of the hollow leg member 134. When the spacer element 135 is urged against the proximal face of the work piece A, the proximal end of the spacer element 135 may urge the hollow leg member 134 into the position of engagement.

In this way, the spacer element 135 causes engagement of the threaded portion of the hollow leg member 134 with the threaded portion of the bolt 132. As such, there is no free movement or ‘float’ along the central axis between the threaded portions. Rotation of the bolt 132 in the first direction will immediately engage the threaded portions. In addition, there is no free movement of the bolt 132 with respect to the hollow tubular body 133. As such, an automatic system may easily locate the head of the bolt 132, and engage a rotary tool to tighten the fastener 130.

In the position of engagement shown, rotation of the bolt 132 in the first direction may cause the threaded portion of the hollow leg member 134 to engage with the threaded portion of the bolt 132. In this way, the spacer element 135 can cause immediate engagement of the threads when required. Movement of the bolt 132 with respect to the hollow tubular body 133 is not required to engage the threads. In this way, there is no movement or ‘float’ in the distal end of the bolt 132, relative to the hollow tubular body 133. As such, the fastener 130 can enable an automated system to more efficiently locate the head of the bolt 132, and engage a rotary tool to tighten the fastener 130.

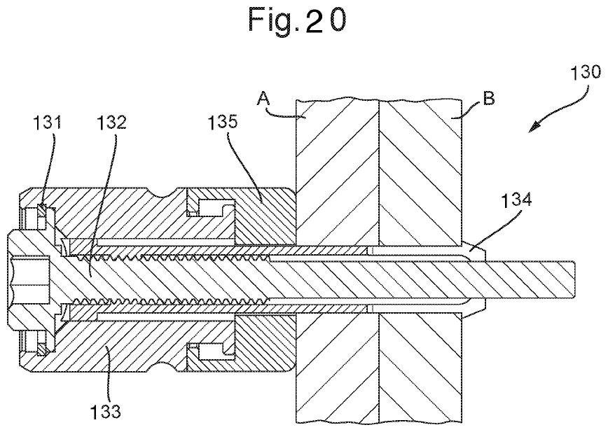

FIG. 20 of the accompanying drawings shows the fastener 130 after rotation of the bolt 132 in the first direction. The fastener 130 is shown in a fully clamped position. A compressive force is applied between a distal face of the spacer element 135 and a proximally facing flat surface formed on the resilient legs of the hollow leg member 134.

As shown, the hollow leg member 134 is translated in a proximal direction relative to the bolt 132. The resilient legs of the hollow leg member 134 do not extend beyond the distal end of the bolt 132. In this position, the distal end of the bolt 132 is configured to urge the resilient legs of the hollow leg member radially outwards.

In some embodiments, the resilient legs may be formed of a resilient material such that each of the legs can be deflected inwards or outwards by a deflecting force, e.g. by the bolt 132. Provided the amount of deflection does not exceed a material limit, the resilient legs may be configured to return to the original biased position if the deflecting force is removed.

Each of the resilient legs of the hollow leg member 134 has a head at the distal end. The head may be formed as a flange portion extending radially outwards from the leg. As shown, when the resilient legs are deflected outwards by the bolt 132, the head of each leg may protrude outwards beyond the radial extent of the hollow leg member 134. The head of each leg may protrude outwards beyond the opening in part B. In this configuration, the fastener 130 cannot be withdrawn from the workpiece.

The head of each leg is configured to engage with the work-piece. For example, the head of each leg may be arranged to engage with a distal side of part B and transfer a compressive force to part B. The flange portion forming the head of each leg may include a flat surface, which is presented perpendicular to the central axis and arranged to abut with the distal face of part B.

As described above, the action of the spacer element 135 causes engagement of the threaded portion of the hollow leg member 134 with the threaded portion of the bolt 132, such that rotation of the bolt 132 in the first direction will immediately engage the threaded portions. In this way, a grip range of the fastener 130 can be improved. As soon as the head of each resilient leg can engage a distal face of the work piece, each head exert a compressive force on the work piece. This compressive force can be applied from virtually the most distal position of the hollow leg member 134, as the threaded portions of the fastener 130 are engaged by the action of the spacer element 135.

Although aspects of the invention herein have been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the scope of the invention as defined by the appended claims.

### NEW EMBODIMENT

The present invention relates to a fastener. In particular, the invention relates to a single-sided temporary fastener including a free-spin feature, which can prevent damage to the fastener on removal.

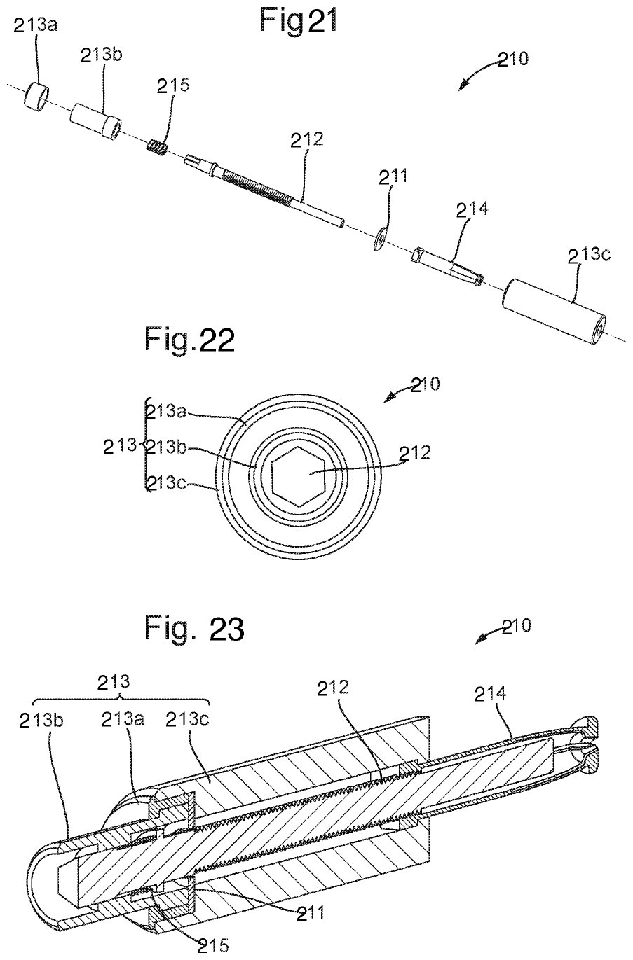

FIG. 21 of the accompanying drawings shows a fastener 210 comprising a retaining ring 211, a bolt 212, a first hollow tubular body part 213a, a second hollow tubular body part 213b, a third hollow tubular body part 213c, a hollow leg member 214 and a spring 215. Each of the components has a central axis, about which the component is substantially symmetric. The components are configured to form the fastener 210 when assembled. In some examples, the central axis of each component is aligned when the fastener 210 is assembled. Each of the components has a distal end, defined as the end furthest from the user in normal use, and a proximal end defined as the end closest to the user in normal use. The assembled fastener 210 has a corresponding distal end and proximal end.

The retaining ring 211 has a ring shape with a central opening. In some embodiments, the retaining ring 211 may have a substantially flat profile. In some examples, the retaining ring 211 may be a stamped circlip or a spiral snap ring, e.g. a Spiralox® retaining ring.

The bolt 212 has a substantially cylindrical shape. The bolt 212 has a proximal end and a distal end. The bolt 212 comprises a threaded portion at or near to the proximal end. In some examples, the threaded portion of the bolt 212 may cover at least a portion of a proximal half of the length of the bolt 212. In some embodiments, the bolt 212 may have an external thread. A thread of the threaded portion may extend radially outwards from a central cylindrical portion. Alternatively, the thread may be cut radially inwards into the central cylindrical portion. The threaded portion of the bolt 212 is configured to engage with a threaded portion of the hollow leg member 214.

In some embodiments, the proximal end of the bolt 212 may have a flange. The flange of the bolt 212 may be configured to engage with the ring 211 to limit a position of the bolt 212.

The first hollow tubular body part 213a is configured to form a hollow tubular body 213 with the second hollow tubular body part 213b and the third hollow tubular body part 213c. The first hollow tubular body part 213a may be referred to as a proximal tube. The second hollow tubular body part 213b may be referred to as a rotatable cap. The third hollow tubular body part 213c may be referred to as a distal tube. In some embodiments, any of the first hollow tubular body part 213a, second hollow tubular body part 213b and/or third hollow tubular part 213c may be screwed together. Alternatively, any of the first hollow tubular body part 213a, second hollow tubular body part 213b and/or third hollow tubular part 213c may connected by a press-fit, welding, adhesive any other suitable means. In some embodiments, the hollow tubular body 213 is formed as a single piece.

The hollow tubular body 213 has a proximal end and a distal end. The proximal end may be formed by the second hollow tubular body part 213b and the distal end may be formed by the third hollow tubular body part 213c. The distal end of the hollow tubular body 213 may be a flat surface perpendicular to the central axis or may have a conical (or “countersunk”) profile. The hollow tubular body 213 has a central axis. In some embodiments, the central axis of the hollow tubular body 213 defines the central axis of the fastener 210. The hollow tubular body 213 has a central opening extending along the central axis from the proximal end to the distal end. The hollow tubular body 213 is configured to receive the retaining ring 211, the bolt 212, the hollow leg member 214 and the spring 215 within the central opening.

In some embodiments, the first hollow tubular body part 213a may be formed as a cylindrical sleeve configured to retain the second hollow tubular body part 213b within. The second hollow tubular body part 213b may be rotatable with respected to the first hollow tubular body part 213a. In some examples, the bolt 212 may be received within a central opening of the second hollow tubular body part 213b. The bolt 212 may be translatable along the central axis relative to the second hollow tubular body part 213b. In some examples, the bolt 212 may be rotatably coupled with the second hollow tubular body part 213b. For example, a coupling portion of the bolt 212 may have a polygon profile e.g. a hexagonal profile. The central opening of second hollow tubular body part 213b may have a corresponding polygonal profile to rotatably couple the second hollow tubular body part 213b with the bolt 212. In some examples, the coupling portion of the bolt 212 may be formed proximally of the threaded portion of the bolt 212.

The hollow leg member 214 has a hollow, substantially cylindrical form. The hollow leg member 214 has a proximal end and a distal end. The hollow leg member 214 comprises a flange at the proximal end, a threaded portion at the proximal end and a plurality of resilient legs at the distal end. The flange extends radially outwards from the proximal end of the flange. In some embodiments, the flange of the hollow leg member 214 may include a flat surface perpendicular to the central axis of the fastener. The flat surface of the flange may face the distal direction.

Each of the resilient legs of the hollow leg member 214 has a head at the distal end. The head may be formed as a flange portion extending radially outwards from the leg. The head of each leg is configured to engage with a work-piece. For example, the head of each leg may be arranged to engage with a distal side of the work piece. As will be described later, the head may be configured to transfer a compressive force to the work piece.

In some embodiments, the resilient legs of the hollow leg member 214, may be formed to extend distally from the distal end of the hollow leg member 214. Alternatively, the legs may be formed by dividing the distal end of the hollow leg member 214. A portion of material may be removed from the hollow leg member 214 between each of the legs.

Each of the resilient legs of the hollow leg member is biased radially inwards towards the central axis. That is, the distal ends of the resilient legs may be angled or curved radially inwards towards the central axis. The resilient legs may be formed of a resilient material such that each of the legs can be deflected inwards or outwards by a deflecting force. Provided the amount of deflection does not exceed a material limit, the resilient legs may be configured to return to the original biased position if the deflecting force is removed. In some examples, the resilient legs may be biased by, for example, inward deflection of the legs beyond the material limit, or by applying heat treatment while the legs are restrained in the biased position, or by any suitable process.

In some embodiments, the spring 215 may be a compressive spring. In some examples, the spring 4 may an open coil spring, a disc spring, or any other suitably resilient or elastic element. The spring 215 may be configured to fit around the bolt 212.

FIG. 22 of the accompanying drawings shows a proximal end view of the fastener 210 in assembled form. As shown, the bolt 212 is arranged within the second hollow tubular body part 213b. The second hollow tubular body part 213b is arranged within the first hollow tubular body part 213a. The first hollow tubular body part 213a is arranged within the third hollow tubular body part 213c. In some examples, the proximal end of the bolt 212 may include an engaging element configured to engage with a rotary tool. For example, the head of the bolt 212 may be formed with a polygonal, e.g. hexagonal (as shown) or square, shape for engagement with a wrench, or may include a socket or recess having a shape for engagement with a socket wrench, key, or screwdriver e.g. a hexagonal, triangular, square, linear, cross or star shaped recess.

FIG. 23 of the accompanying drawings shows the fastener 210 in assembled form. As shown, the central axis of each component is aligned when the fastener 210 is assembled.

As shown, the first hollow tubular body part 213a may form a hollow tubular body 213 with the second hollow tubular body part 213b and the third hollow tubular body part 213c. The first hollow tubular body part 213a and third hollow tubular body part 213c may be connected by a press-fit or, alternatively, may be screwed together. The second hollow tubular body part 213b may be held in position by the first hollow tubular body part 213a, e.g. by a flange or lip. The second hollow tubular body part 213b may be rotatable with respect to the first hollow tubular body part 213a

The hollow tubular body 213 has a proximal end and a distal end. The proximal end may be formed by the second hollow tubular body part 213b and the distal end may be formed by the third hollow tubular body part 213c. The distal end of the hollow tubular body 213 may be a flat surface perpendicular to the central axis or may have a conical (or “countersunk”) profile. The hollow tubular body 213 has a central axis. In some embodiments, the central axis of the hollow tubular body 213 defines the central axis of the fastener 210. The hollow tubular body 213 has a central opening extending along the central axis from the proximal end to the distal end. As shown, each of the retaining ring 211, the bolt 212, the hollow leg member 214 and the spring 215 are at least partially received within the central opening.

The bolt 212 has a substantially cylindrical form. As shown, the bolt 212 may be arranged within the central opening of the hollow tubular body 213. The bolt 212 may extend by a distance beyond the distal end of the hollow tubular body 213. In some examples, the proximal end (or “head”) of the bolt 212 may protrude from the proximal end of the hollow tubular body 213. Alternatively, the head of the bolt 212 may be within the proximal end of the central opening.

In some embodiments, the proximal end of the bolt 212 may have a flange. The flange may be formed to extend radially outwards from the cylindrical body of the bolt 212.

In some embodiments, the hollow tubular body 213 may have a retaining means configured to engage with the flange of the bolt 212 and block the bolt 212 from moving in a distal direction. For example, the second hollow tubular body part 213b may comprise a lip extending radially inwards into the central opening at or near the distal end of the second hollow tubular body part 213b. In some embodiments, as shown, the retaining means may be provided by the retaining ring 211.

The retaining ring 211 has a ring shape with a central opening. In some embodiments, the retaining ring 211 may have a substantially flat profile. In some examples, the retaining ring 211 may be a stamped circlip or a spiral snap ring, e.g. a Spiralox retaining ring. As shown, the hollow tubular body 213 may comprise a retaining groove arranged to receive the retaining ring 2. The retaining groove may be positioned between the first and/or second hollow tubular body parts 213a, 213b and the third hollow tubular body part 213c.

The flange of the bolt 212 may be configured to engage with the ring 211 to limit a position of the bolt 212. The central opening of the ring 211 may be formed to fit around the cylindrical body of the bolt 212. The flange of the bolt 212 may be foamed with a diameter, which is larger than the central opening of the ring 211. The ring 211 may be positioned around the cylindrical body of the bolt 212, distally from the flange of the bolt 212. The ring 211 may engage with the flange of the bolt 212 to block the bolt 212 from movement in a distal direction.

The hollow tubular body 213 comprises a stop surface extending radially inwards at the proximal end. For example, the second hollow tubular body part 213b may be formed with a lip extending radially inwards into the central opening of the hollow tubular body 213. In some examples, a shoulder or step profile may be formed to extend radially inwards into the central opening of the hollow tubular body 213. In some embodiments, the stop surface of the hollow tubular body 213 may have be formed as a flat surface of the step profile extending perpendicular to the central axis of the fastener. The flat surface of the stop portion may face the distal direction.

The spring 215 is arranged between the flange of the bolt 212 and the stop surface of the hollow tubular body 213. In some embodiments, the spring 215 may be a compressive spring. In some examples, the spring 215 may an open coil spring, a disc spring, or any other suitably resilient or elastic element. The spring 215 may be configured to fit around a cylindrical portion of the bolt 212 and abut with the proximally facing flat surface of the flange. The spring 215 is configured to urge the bolt 212 in a distal direction with respect to the hollow tubular body 213. For example, the spring 215 may be configured to exert a force on the proximally facing flat surface of the bolt 212 and distally facing stop surface of the hollow tubular body 213.

In this way, the spring 215 and/or the stop surface of the hollow tubular body 213 may be configured to block the bolt 212 from moving in the proximal direction.

The bolt 212 comprises a threaded portion at the proximal end. In some embodiments, the bolt 212 may have an external thread. A thread of the threaded portion may extend radially outwards from a central cylindrical portion. Alternatively, the thread may be cut radially inwards into the central cylindrical portion. The threaded portion of the bolt 212 is configured to engage with a threaded portion of the hollow leg member 214.

The hollow leg member 214 has a hollow, substantially cylindrical form. The hollow leg member comprises a plurality of resilient legs at the distal end. In some embodiments, the resilient legs of the hollow leg member 214, may be formed to extend distally from the distal end of the hollow leg member 214. Alternatively, the legs may be formed by dividing the distal end of the hollow leg member 214. A portion of material may be removed from the hollow leg member 214 between each of the legs.

As shown, the hollow leg member 214 may be arranged within the central opening of the hollow tubular body 213. The hollow leg member 214 may extend by a distance beyond the distal end of the hollow tubular body 213. The hollow leg member is translatable within the hollow tubular body 213 along the central axis of the hollow tubular body 213.

The hollow leg member 214 comprises a flange at the proximal end. The flange extends radially outwards from the proximal end of the flange. In some embodiments, the flange of the hollow leg member 214 may include a flat surface perpendicular to the central axis of the fastener. The flat surface of the flange may face the distal direction.

In some examples, the hollow tubular body 213 may comprise a stop portion extending radially inwards at the distal end. For example, the third hollow tubular body part 213c may be formed with a lip extending radially inwards into the central opening of the hollow tubular body 213. In some embodiments, the stop portion of the hollow tubular body 213 may have a flat surface perpendicular to the central axis of the fastener. The flat surface of the stop portion may face the proximal direction. The stop portion of the hollow tubular body 213 may engage with the flange of the hollow leg member 214 to block the hollow leg member 214 from movement in the distal direction.

Each of the resilient legs of the hollow leg member 214 is biased radially inwards towards the central axis. That is, the distal ends of the resilient legs may be angled or curved radially inwards towards the central axis. In some examples, the resilient legs may be biased by, for example, inward deflection of the legs beyond the material limit, or by applying heat treatment while the legs are restrained in the biased position, or by any suitable process. As shown, a portion of the resilient legs, which extends beyond the distal end of the bolt 212 may be angled or curved radially inwards. In some embodiments, the distal ends of the legs may extend beyond the distal end of the bolt 212 when the hollow leg member 214 is in the most distal position, as shown in FIG. 3.

The hollow leg member 214 comprises a threaded portion at the proximal end. In some embodiments, the hollow leg member 214 may have an internal thread. For example, the hollow leg member 214 may include a thread extending radially inwards from an inner wall of the hollow cylindrical form. Alternatively, the thread may be cut radially outwards into the inner wall of the hollow cylindrical form.

The threaded portion of the bolt 212 is configured to engage with a threaded portion of the hollow leg member 214. In this way, rotation of the bolt 212 in a first direction draws the hollow leg member 214 in a proximal direction along the central axis. The first direction may be referred to as a fastening, tightening or clamping direction. In some examples, the first direction may be clockwise from the perspective of the user. Alternatively, the first direction may be anti-clockwise. By rotation of the bolt 212 in the first direction, the hollow leg member 214 may be translated in a proximal direction relative to the bolt 212. The hollow leg member 214 may also be translated in a proximal direction relative to the hollow tubular body 213. In some examples, the hollow leg member 214 may be drawn further within the central opening of the hollow tubular body 213. In some examples, the resilient legs of the hollow leg member 214 may be moved in a proximal direction towards or past the distal end of the hollow tubular body 213.

Rotation of the bolt 212 in a second direction opposite to the first direction is configured to translate the hollow leg member 214 in a distal direction along the central axis. The second direction may be referred to as an unfastening, loosening or detaching direction.

In some examples, where the first direction is clockwise from the perspective of the user, the second direction may be anti-clockwise and vice versa. By rotation of the bolt 212 in the second direction, the hollow leg member 214 may be translated in a distal direction relative to the bolt 212. The hollow leg member 214 may also be translated in a distal direction relative to the hollow tubular body 213. In some examples, the hollow leg member 214 may be pushed further out of the central opening of the hollow tubular body 213. In some examples, the resilient legs of the hollow leg member 214 may be moved in a distal direction away from the distal end of the hollow tubular body 213.

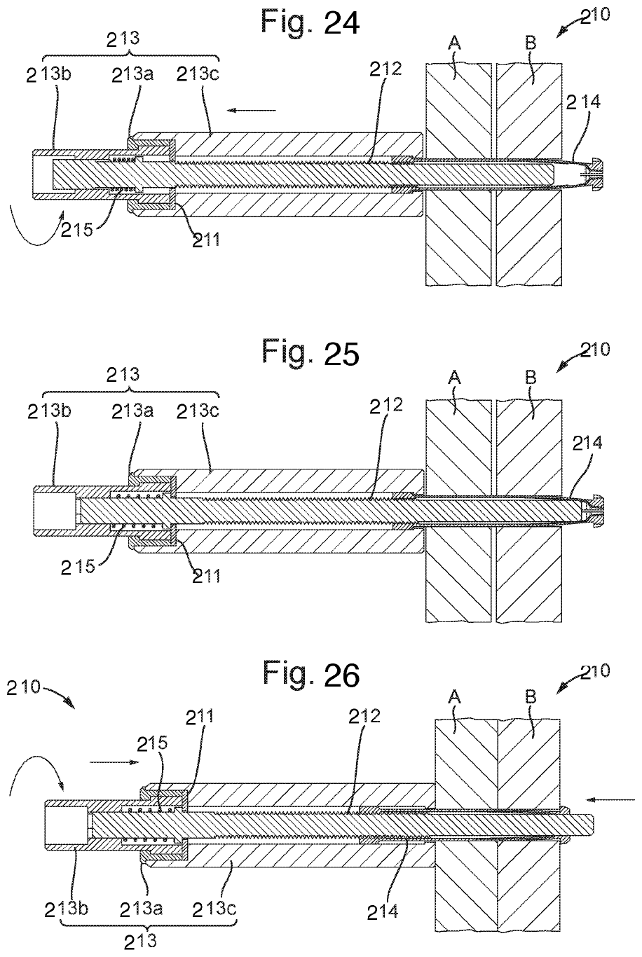

FIG. 24 of the accompanying drawings shows the fastener 210 in an initial configuration, e.g. after rotation of the bolt 212 in the second direction. As shown, the fastener 210 is in position to clamp a workpiece with two parts, A and B. An opening is prepared through part A and part B.

After rotation of the bolt 212 in the second direction the hollow leg member 214 is translated in a distal direction relative to the bolt 212. As shown, the hollow leg member 214 is in the most distal position. The resilient legs of the hollow leg member 214 extend beyond the distal end of the bolt 212. Each of the resilient legs of the hollow leg member 214 is biased radially inwards towards the central axis. In this position, the distal end of the bolt 212 does not urge the resilient legs of the hollow leg member radially outwards. As shown, a portion of the resilient legs, which extends beyond the distal end of the bolt 212 may be angled or curved radially inwards. In this way, the head at the distal end of each resilient leg can pass through the openings in the work piece. The hollow leg member 214 can pass through the opening, but the hollow tubular body 213 is larger than the opening. A distal face of the hollow tubular body 213 abuts with a proximal face of part A.

Rotation in the second direction causes the threaded portion of the bolt 212 to disengage from the threaded portion of the hollow leg portion 214. As the threaded portion of the hollow leg member 214 is at the proximal end of the hollow leg member 214, the threaded portion of the bolt 212 may be translated proximally out of the threaded portion of the hollow leg member 214. The bolt 212 may be translatable in a distal direction along the central axis. In this way, the threaded portion of the bolt 212 can be disengaged from the threaded portion of the hollow leg member 214. In this configuration, the bolt 212 can be freely rotated in the second direction. In this way, damage caused to the fastener by over-rotation of the bolt 212 in the second direction can be avoided.

The spring 215 is configured to urge the bolt 212 in a distal direction with respect to the hollow tubular body 213. Further rotation of the bolt 212 in the second direction may push the bolt 212 proximally against the spring 215, compressing the spring 215 as shown. The spring 215 may maintain a contact between the thread of the bolt 212 and the thread of the hollow leg member 214. A user with a manual rotary tool may feel a clicking sensation when further rotating the bolt 212 in the second direction. In some embodiments, the spring 215 may be configured to urge the bolt 212 into a position of engagement. In the position of engagement, the threaded portion of the bolt 212 may be engaged with the threaded portion of the hollow leg member 214.

FIG. 25 of the accompanying drawings shows the fastener 210 in a configuration with the bolt 212 in the position of engagement.

The spring 215 urges the bolt 212 in a distal direction relative to the hollow tubular body 213. In the position of engagement, rotation of the bolt 212 in the first direction may cause the threaded portion of the bolt 212 to engage with the threaded portion of the hollow leg member 214. In this way, the spring 215 can cause immediate engagement of the threads when required. For example, the spring 215 causes engagement of the threaded portion of the bolt 212 with the threaded portion of the hollow leg member 214. As such, there is no free movement or ‘float’ along the central axis between the threaded portions. Movement of the bolt 212 with respect to the hollow tubular body 213 is not required to engage the threads. Rotation of the bolt 212 in the first direction will immediately engage the threaded portions. In addition, there is no free movement of the bolt 212 with respect to the hollow tubular body 213. In this way, there is no movement or ‘float’ in the distal end of the bolt 212, relative to the hollow tubular body 213. As such, the fastener 210 can enable an automated system to more efficiently locate the head of the bolt 212, and engage a rotary tool to tighten the fastener 210.

FIG. 26 of the accompanying drawings shows the fastener 210 after rotation of the bolt 212 in the first direction. The fastener 210 is shown in a fully clamped position. As shown, the hollow leg member 214 is translated in a proximal direction relative to the bolt 212. The resilient legs of the hollow leg member 214 do not extend beyond the distal end of the bolt 212. In this position, the distal end of the bolt 212 is configured to urge the resilient legs of the hollow leg member radially outwards. A compressive force is applied between a distal face of the hollow tubular body 213 and a proximally facing flat surface formed on the resilient legs of the hollow leg member 214.

In some embodiments, the resilient legs may be formed of a resilient material such that each of the legs can be deflected inwards or outwards by a deflecting force, e.g. by the bolt 212. Provided the amount of deflection does not exceed a material limit, the resilient legs may be configured to return to the original biased position if the deflecting force is removed.

Each of the resilient legs of the hollow leg member 214 has a head at the distal end. The head may be formed as a flange portion extending radially outwards from the leg. As shown, when the resilient legs are deflected outwards by the bolt 212, the head of each leg may protrude outwards beyond the radial extent of the hollow leg member 214. The head of each leg may protrude outwards beyond the opening in part B. In this configuration, the fastener 210 cannot be withdrawn from the workpiece.

The head of each leg is configured to engage with a work-piece. For example, the head of each leg may be arranged to engage with a distal side of the work piece. In some examples, the flange portion forming the head of each leg may include a flat surface, which is presented perpendicular to the central axis and proximally facing when the hollow leg member 214 is in the position shown. The flat surface may be arranged to abut with the distal face of part B and transfer a compressive force to part B.

The spring 215 causes engagement of the threaded portion of the bolt 212 with the threaded portion of the hollow leg member 214, such that rotation of the bolt 212 in the first direction will immediately engage the threaded portions. In this way, a grip range of the fastener 210 can be improved. As soon as the head of each resilient leg can engage a distal face of the work piece, each head exert a compressive force on the work piece. This compressive force can be applied from virtually the most distal position of the hollow leg member 214, as the threaded portions of the fastener 210 are engaged by the spring 215.

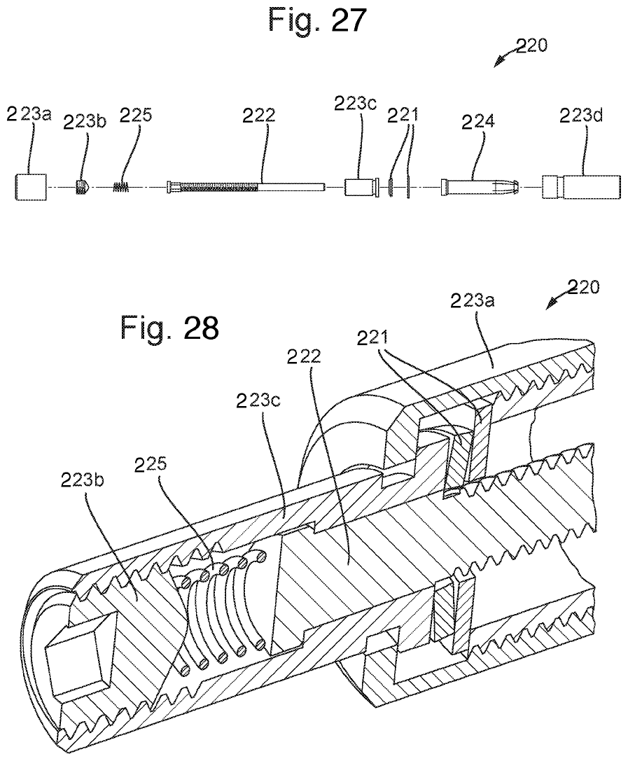

FIG. 27 of the accompanying drawings shows a fastener 20 comprising a retaining ring 221, a bolt 22, a first hollow tubular body part 23a, a second hollow tubular body part 23b, a third hollow tubular body part 23c, a fourth hollow tubular body part 23d, a hollow leg member 24 and a spring 25. Each of the components has a central axis, about which the component is substantially symmetric. The components are configured to form the fastener 20 when assembled. In some examples, the central axis of each component is aligned when the fastener 20 is assembled. Each of the components has a distal end, defined as the end furthest from the user in normal use, and a proximal end defined as the end closest to the user in normal use. The assembled fastener 20 has a corresponding distal end and proximal end.

The retaining ring 221 has a ring shape with a central opening. In some embodiments, the retaining ring 221 may have a substantially flat profile. In some examples, the retaining ring 221 may be formed as a disc spring, a flat coil spring, a stamped circlip or a spiral snap ring, or any combination of one or more such elements in combination.

The bolt 22 has a substantially cylindrical shape. The bolt 22 has a proximal end and a distal end. The bolt 22 comprises a threaded portion at or near to the proximal end. In some examples, the threaded portion of the bolt 22 may cover at least a portion of a proximal half of the length of the bolt 22. In some embodiments, the bolt 22 may have an external thread. A thread of the threaded portion may extend radially outwards from a central cylindrical portion. Alternatively, the thread may be cut radially inwards into the central cylindrical portion. The threaded portion of the bolt 22 is configured to engage with a threaded portion of the hollow leg member 24.

In some embodiments, the proximal end of the bolt 22 may have a flange. The flange of the bolt 22 may be configured to engage with the third hollow tubular body part 23c to limit a position of the bolt 22.

The first hollow tubular body part 23a is configured to form a hollow tubular body 23 with the third hollow tubular body part 23c and the fourth hollow tubular body part 23d. The first hollow tubular body part 23a may be referred to as a proximal tube. The fourth hollow tubular body part 23d may be referred to as a distal tube. In some embodiments, any of the first hollow tubular body part 23a, second hollow tubular body part 23b, third hollow tubular body part 23c and/or third hollow tubular part 213c may be screwed together. Alternatively, any of the first hollow tubular body part 23a, third hollow tubular body part 23c and/or third hollow tubular part 213c may connected by a press-fit, welding, adhesive any other suitable means. In some embodiments, the hollow tubular body 23 is formed as a single piece.

The hollow tubular body 23 has a proximal end and a distal end. The proximal end may be formed by the third hollow tubular body part 23c and the distal end may be formed by the fourth hollow tubular body part 23d. The distal end of the hollow tubular body 23 may be a flat surface perpendicular to the central axis or may have a conical (or “countersunk”) profile. The hollow tubular body 23 has a central axis. In some embodiments, the central axis of the hollow tubular body 23 defines the central axis of the fastener 20. The hollow tubular body 23 has a central opening extending along the central axis from the proximal end to the distal end. The hollow tubular body 23 is configured to received the retaining ring 221, the bolt 22, the hollow leg member 24 and the spring 25 within the central opening.

The second hollow tubular body part 23b and third hollow tubular body part 23c may form a rotatable cap. In some examples, the third hollow tubular body part 23c may have a substantially cylindrical form. The second hollow tubular body part 23b may be formed to fit within the proximal end of the third hollow tubular body part 23c. The second hollow tubular body part 23b may fill or otherwise block the central opening of the hollow tubular body 23. The second hollow tubular body part 23b may form an end wall of the hollow tubular body 23.

The hollow leg member 24 has a hollow, substantially cylindrical form. The hollow leg member 24 has a proximal end and a distal end. The hollow leg member 24 comprises a flange at the proximal end, a threaded portion at the proximal end and a plurality of resilient legs at the distal end. The flange extends radially outwards from the proximal end of the flange. In some embodiments, the flange of the hollow leg member 24 may include a flat surface perpendicular to the central axis of the fastener. The flat surface of the flange may face the distal direction.

Each of the resilient legs of the hollow leg member 24 has a head at the distal end. The head may be formed as a flange portion extending radially outwards from the leg. The head of each leg is configured to engage with a work-piece. For example, the head of each leg may be arranged to engage with a distal side of the work piece. As will be described later, the head may be configured to transfer a compressive force to the work piece.

In some embodiments, the resilient legs of the hollow leg member 24, may be formed to extend distally from the distal end of the hollow leg member 24. Alternatively, the legs may be formed by dividing the distal end of the hollow leg member 24. A portion of material may be removed from the hollow leg member 24 between each of the legs.

Each of the resilient legs of the hollow leg member is biased radially inwards towards the central axis. That is, the distal ends of the resilient legs may be angled or curved radially inwards towards the central axis. The resilient legs may be formed of a resilient material such that each of the legs can be deflected inwards or outwards by a deflecting force. Provided the amount of deflection does not exceed a material limit, the resilient legs may be configured to return to the original biased position if the deflecting force is removed. In some examples, the resilient legs may be biased by, for example, inward deflection of the legs beyond the material limit, or by applying heat treatment while the legs are restrained in the biased position, or by any suitable process.

In some embodiments, the spring 25 may be a compressive spring. In some examples, the spring 4 may an open coil spring, a disc spring, or any other suitably resilient or elastic element.

FIG. 28 of the accompanying drawings shows the fastener 20 in assembled form. As shown, the central axis of each component is aligned when the fastener 20 is assembled.

As shown, the first hollow tubular body part 23a may form a hollow tubular body 23 with the second hollow tubular body part 23b, third hollow tubular body part 23c and the fourth hollow tubular body part 23d. The first hollow tubular body part 23a and fourth hollow tubular body part 23d may be connected by a press-fit or, alternatively, may be screwed together. The third hollow tubular body part 23c may be held in position by the first hollow tubular body part 23a, e.g. by a flange or lip. The third hollow tubular body part 23c may be rotatable with respect to the first hollow tubular body part 23a

The hollow tubular body 23 has a proximal end and a distal end. The proximal end may be formed by the third hollow tubular body part 23c and the distal end may be formed by the fourth hollow tubular body part 23d. The distal end of the hollow tubular body 23 may be a flat surface perpendicular to the central axis or may have a conical (or “countersunk”) profile. The hollow tubular body 23 has a central axis. In some embodiments, the central axis of the hollow tubular body 23 defines the central axis of the fastener 20. The hollow tubular body 23 has a central opening extending along the central axis from the proximal end to the distal end. As shown, each of the retaining ring 221, the bolt 22, the hollow leg member 24 and the spring 25 are at least partially received within the central opening.

The bolt 22 has a substantially cylindrical form. As shown, the bolt 22 may be arranged within the central opening of the hollow tubular body 23. The bolt 22 may extend by a distance beyond the distal end of the hollow tubular body 23. In some examples, the proximal end of the bolt 22 may be within the proximal end of the central opening. In some embodiments, the proximal end of the bolt 22 may have a flange. The flange may be formed to extend radially outwards from the cylindrical body of the bolt 22. In some embodiments, the proximal end face of the bolt 22 may form a proximally-facing stop surface.

In some embodiments, the hollow tubular body 23 may have a retaining means configured to engage with the flange of the bolt 22 and block the bolt 22 from moving in a distal direction. For example, the third hollow tubular body part 23c may have a shoulder arranged to block the bolt 22 from moving in a distal direction. The shoulder may be formed to extend radially inwards into the central opening of the hollow tubular body 23. The shoulder may be arranged to engage with the flange of the bolt 22, to fix the bolt in position with respect to the hollow tubular body 23.

As shown, the second hollow tubular body part 23b and third hollow tubular body part 23c may form a rotatable cap. In some examples, the third hollow tubular body part 23c may have a substantially cylindrical form. The second hollow tubular body part 23b may be formed to fit within the proximal end of the third hollow tubular body part 23c. The second hollow tubular body part 23b may fill or otherwise block the central opening of the hollow tubular body 23.

The second hollow tubular body part 23b may form an end wall closing the hollow tubular body 23. In some examples, a proximally facing outer face of the end wall may include an engaging element configured to engage with a rotary tool. For example, the second hollow tubular body part 23b may be formed with a polygonal, e.g. hexagonal or square, shape for engagement with a wrench, or may include a socket or recess (as shown) having a shape for engagement with a socket wrench, key, or screwdriver e.g. a hexagonal, triangular, square, linear, cross or star shaped recess. In some examples, an inner face of the end wall may form a distally-facing stop surface. In some examples, the inner face may be flat or may be shaped to correspond with the spring 25. For example, the inner face may include a cone-shaped profile or a grooved profile to maintain the spring 25 in a centred position.

The spring 25 is arranged between the proximally-facing stop surface of the bolt 22 and the distally-facing stop surface of the second hollow tubular body part 23b. In some embodiments, the spring 25 may be a compressive spring. In some examples, the spring 25 may an open coil spring, a disc spring, or any other suitably resilient or elastic element. The spring 25 is configured to urge the bolt 22 in a distal direction with respect to the hollow tubular body 23. For example, the spring 25 may be configured to exert a force on the proximally facing flat surface of the bolt 22 and distally facing stop surface of the hollow tubular body 23.

In this way, the spring 25 and/or the stop surface of the hollow tubular body 23 may be configured to block the bolt 22 from moving in the proximal direction.

The bolt 22 comprises a threaded portion at the proximal end. In some embodiments, the bolt 22 may have an external thread. A thread of the threaded portion may extend radially outwards from a central cylindrical portion. Alternatively, the thread may be cut radially inwards into the central cylindrical portion. The threaded portion of the bolt 22 is configured to engage with a threaded portion of the hollow leg member 24.

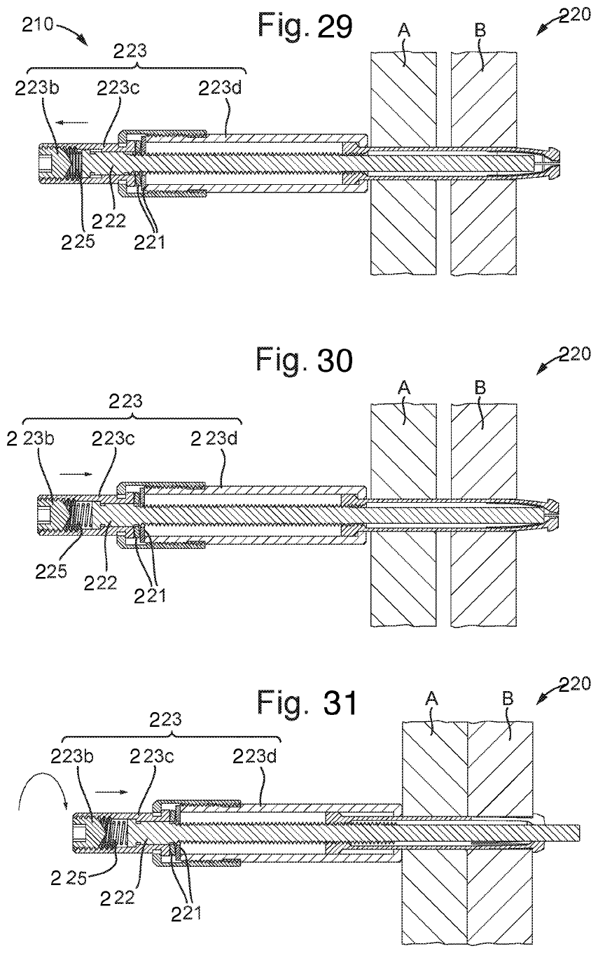

FIG. 29 of the accompanying drawings shows the fastener 20 in an initial configuration. As shown, the fastener 20 is in position to clamp a workpiece with two parts, A and B. An opening is prepared through part A and part B.

As shown, the hollow leg member 24 may be arranged within the central opening of the hollow tubular body 23. The hollow leg member 24 has a hollow, substantially cylindrical form. The hollow leg member comprises a plurality of resilient legs at the distal end. In some embodiments, the resilient legs of the hollow leg member 24, may be formed to extend distally from the distal end of the hollow leg member 24. Alternatively, the legs may be formed by dividing the distal end of the hollow leg member 24. A portion of material may be removed from the hollow leg member 24 between each of the legs.

The hollow leg member 24 may extend by a distance beyond the distal end of the hollow tubular body 23. The hollow leg member is translatable within the hollow tubular body 23 along the central axis of the hollow tubular body 23. The hollow leg member 24 comprises a flange at the proximal end. The flange extends radially outwards from the proximal end of the flange. In some embodiments, the flange of the hollow leg member 24 may include a flat surface perpendicular to the central axis of the fastener. The flat surface of the flange may face the distal direction.

In some examples, the hollow tubular body 23 may comprise a stop portion extending radially inwards at the distal end. For example, the fourth hollow tubular body part 23d may be formed with a lip extending radially inwards into the central opening of the hollow tubular body 23. In some embodiments, the stop portion of the hollow tubular body 23 may have a flat surface perpendicular to the central axis of the fastener. The flat surface of the stop portion may face the proximal direction. The stop portion of the hollow tubular body 23 may engage with the flange of the hollow leg member 24 to block the hollow leg member 24 from movement in the distal direction.

As shown, the hollow leg member 24 is in the most distal position. The resilient legs of the hollow leg member 24 extend beyond the distal end of the bolt 22. Each of the resilient legs of the hollow leg member 24 is biased radially inwards towards the central axis. In this position, the distal end of the bolt 22 does not urge the resilient legs of the hollow leg member radially outwards. The distal ends of the resilient legs may be angled or curved radially inwards towards the central axis. In some examples, the resilient legs may be biased by, for example, inward deflection of the legs beyond the material limit, or by applying heat treatment while the legs are restrained in the biased position, or by any suitable process.

As shown, a portion of the resilient legs extends beyond the distal end of the bolt 22 may be angled or curved radially inwards. In this way, the head at the distal end of each resilient leg can pass through the openings in the work piece. The hollow leg member 24 can pass through the opening, but the hollow tubular body 23 is larger than the opening. A distal face of the hollow tubular body 23 abuts with a proximal face of part A.

The hollow leg member 24 comprises a threaded portion at the proximal end. In some embodiments, the hollow leg member 24 may have an internal thread. For example, the hollow leg member 24 may include a thread extending radially inwards from an inner wall of the hollow cylindrical form. Alternatively, the thread may be cut radially outwards into the inner wall of the hollow cylindrical form.

The threaded portion of the bolt 22 is configured to engage with a threaded portion of the hollow leg member 24. In this way, rotation of the bolt 22 in a first direction draws the hollow leg member 24 in a proximal direction along the central axis. The first direction may be referred to as a fastening, tightening or clamping direction. In some examples, the first direction may be clockwise from the perspective of the user. Alternatively, the first direction may be anti-clockwise. By rotation of the bolt 22 in the first direction, the hollow leg member 24 may be translated in a proximal direction relative to the bolt 22. The hollow leg member 24 may also be translated in a proximal direction relative to the hollow tubular body 23. In some examples, the hollow leg member 24 may be drawn further within the central opening of the hollow tubular body 23. In some examples, the resilient legs of the hollow leg member 24 may be moved in a proximal direction towards or past the distal end of the hollow tubular body 23.

Rotation of the bolt 22 in a second direction opposite to the first direction is configured to translate the hollow leg member 24 in a distal direction along the central axis. The second direction may be referred to as an unfastening, loosening or detaching direction. In some examples, where the first direction is clockwise from the perspective of the user, the second direction may be anti-clockwise and vice versa. By rotation of the bolt 22 in the second direction, the hollow leg member 24 may be translated in a distal direction relative to the bolt 22. The hollow leg member 24 may also be translated in a distal direction relative to the hollow tubular body 23. In some examples, the hollow leg member 24 may be pushed further out of the central opening of the hollow tubular body 23. In some examples, the resilient legs of the hollow leg member 24 may be moved in a distal direction away from the distal end of the hollow tubular body 23.

Rotation in the second direction causes the threaded portion of the bolt 22 to disengage from the threaded portion of the hollow leg portion 214. As the threaded portion of the hollow leg member 24 is at the proximal end of the hollow leg member 24, the threaded portion of the bolt 22 may be translated proximally out of the threaded portion of the hollow leg member 24. The bolt 22 may be translatable in a distal direction along the central axis. In this way, the threaded portion of the bolt 22 can be disengaged from the threaded portion of the hollow leg member 24. In this configuration, the bolt 22 can be freely rotated in the second direction. In this way, damage caused to the fastener by over-rotation of the bolt 22 in the second direction can be avoided.

The spring 25 is configured to urge the bolt 22 in a distal direction with respect to the hollow tubular body 23. Further rotation of the bolt 22 in the second direction may push the bolt 22 proximally against the spring 25, compressing the spring 25 as shown. The spring 25 may maintain a contact between the thread of the bolt 22 and the thread of the hollow leg member 24. A user with a manual rotary tool may feel a clicking sensation when further rotating the bolt 22 in the second direction. In some embodiments, the spring 25 may be configured to urge the bolt 22 into a position of engagement. In the position of engagement, the threaded portion of the bolt 22 may be engaged with the threaded portion of the hollow leg member 24.

FIG. 30 of the accompanying drawings shows the fastener 20 in a configuration with the bolt 22 in the position of engagement.

The spring 25 urges the bolt 22 in a distal direction relative to the hollow tubular body 23. In the position of engagement, rotation of the bolt 22 in the first direction may cause the threaded portion of the bolt 22 to engage with the threaded portion of the hollow leg member 24. In this way, the spring 25 can cause immediate engagement of the threads when required. For example, the spring 25 causes engagement of the threaded portion of the bolt 22 with the threaded portion of the hollow leg member 24. As such, there is no free movement or ‘float’ along the central axis between the threaded portions. Movement of the bolt 22 with respect to the hollow tubular body 23 is not required to engage the threads. Rotation of the bolt 22 in the first direction will immediately engage the threaded portions. In addition, there is no free movement of the bolt 22 with respect to the hollow tubular body 23. In this way, there is no movement or ‘float’ in the distal end of the bolt 22, relative to the hollow tubular body 23. As such, the fastener 20 can enable an automated system to more efficiently locate the head of the bolt 22, and engage a rotary tool to tighten the fastener 20.

FIG. 31 of the accompanying drawings shows the fastener 20 after rotation of the bolt 22 in the first direction. The fastener 20 is shown in a fully clamped position. As shown, the hollow leg member 24 is translated in a proximal direction relative to the bolt 22. The resilient legs of the hollow leg member 24 do not extend beyond the distal end of the bolt 22. In this position, the distal end of the bolt 22 is configured to urge the resilient legs of the hollow leg member radially outwards. A compressive force is applied between a distal face of the hollow tubular body 23 and a proximally facing flat surface formed on the resilient legs of the hollow leg member 24.

In some embodiments, the resilient legs may be formed of a resilient material such that each of the legs can be deflected inwards or outwards by a deflecting force, e.g. by the bolt 22. Provided the amount of deflection does not exceed a material limit, the resilient legs may be configured to return to the original biased position if the deflecting force is removed.

Each of the resilient legs of the hollow leg member 24 has a head at the distal end. The head may be formed as a flange portion extending radially outwards from the leg. As shown, when the resilient legs are deflected outwards by the bolt 22, the head of each leg may protrude outwards beyond the radial extent of the hollow leg member 24. The head of each leg may protrude outwards beyond the opening in part B. In this configuration, the fastener 20 cannot be withdrawn from the workpiece.

The head of each leg is configured to engage with a work-piece. For example, the head of each leg may be arranged to engage with a distal side of the work piece. In some examples, the flange portion forming the head of each leg may include a flat surface, which is presented perpendicular to the central axis and proximally facing when the hollow leg member 24 is in the position shown. The flat surface may be arranged to abut with the distal face of part B and transfer a compressive force to part B.

The spring 25 causes engagement of the threaded portion of the bolt 22 with the threaded portion of the hollow leg member 24, such that rotation of the bolt 22 in the first direction will immediately engage the threaded portions. In this way, a grip range of the fastener 20 can be improved. As soon as the head of each resilient leg can engage a distal face of the work piece, each head exert a compressive force on the work piece.

This compressive force can be applied from virtually the most distal position of the hollow leg member 24, as the threaded portions of the fastener 20 are engaged by the spring 25.

Although aspects of the invention herein have been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the scope of the invention as defined by the appended claims.

### EMBODIMENTS

The following embodiments, which are lot limiting, may otherwise describe the invention described herein.
1. A fastener comprising;
   a hollow tubular body (3) with a proximal end and a distal end and a central axis, comprising a stop portion extending radially inwards at the distal end,
   a hollow leg member (4) having a proximal end and a distal end, the hollow leg member being translatable within the body along the central axis of the body, the hollow leg member having a flange at the proximal end, a threaded portion at the proximal end and a plurality of resilient legs at the distal end and wherein each leg has a head at the distal end for engaging with a work-piece, and each leg is biased radially inwards towards the central axis,
   a bolt (2) having a proximal end and a distal end, with a threaded portion at the proximal end for engaging with the threaded portion of the hollow leg member, such that rotation of the bolt in one direction draws the hollow leg member in a proximal direction along the central axis and rotation in the other direction causes the threaded portion of the hollow leg portion to disengage from the threaded portion of the bolt, wherein the distal end of the bolt is configured to urge the legs radially outward; and
   a spring (5) arranged between the flange of the hollow leg member and the stop portion of the hollow tubular body and configured to urge the hollow leg member in a proximal direction with respect to the hollow tubular body.

1. A fastener comprising;
a hollow tubular body with a proximal end and a distal end and a central axis, comprising a stop portion extending radially inwards at the distal end,
a hollow leg member having a proximal end and a distal end, the hollow leg member being translatable within the body along the central axis of the body, the hollow leg member having a flange at the proximal end, a threaded portion at the proximal end and a plurality of resilient legs at the distal end and wherein each leg has a head at the distal end for engaging with a workpiece, and each leg is biased radially inwards towards the central axis,
a bolt having a proximal end and a distal end, with a threaded portion at the proximal end for engaging with the threaded portion of the hollow leg member, such that rotation of the bolt in one direction draws the hollow leg member in a proximal direction along the central axis and rotation in the other direction causes the threaded portion of the hollow leg portion to disengage from the threaded portion of the bolt, wherein the distal end of the bolt is configured to urge the legs radially outward; and
a spring arranged between the flange of the hollow leg member and the stop portion of the hollow tubular body and configured to urge the hollow leg member in a proximal direction with respect to the hollow tubular body.

2. The fastener of claim 1, wherein the flange of the hollow leg member includes a flat surface perpendicular to the central axis of the fastener and the and the stop portion of the hollow tubular body has a corresponding flat surface perpendicular to the central axis of the fastener.

3. The fastener of claim 1, wherein the distal ends of the legs extend beyond the distal end of the bolt when the hollow leg member is in the most distal position.

4. The fastener of claim 1, wherein the spring is configured to urge the hollow leg member into a position of engagement in which the threaded portion of the hollow leg member is engaged with the threaded portion of the bolt.

5. The fastener of claim 1, wherein the proximal end of the bolt has a flange configured to fix the bolt in position with respect to the hollow tubular body, and the hollow tubular body has a shoulder arranged to block the bolt from moving in a distal direction.

6. The fastener of claim 5, wherein the hollow tubular body has a retaining means configured to engage with the flange of the bolt and block the bolt from moving in a proximal direction.

7-11. (canceled)

12. A fastener comprising;
a hollow tubular body with a proximal end and a distal end and a central axis,
a hollow leg member having a proximal end and a distal end, the leg member being translatable within the body along the central axis of the body, the leg member having a threaded portion at the proximal end and a plurality of resilient legs at the distal end and wherein each leg has a head at the distal end for engaging with a workpiece, and each leg is biased radially inwards towards the central axis,
a bolt having a proximal end and a distal end, with a threaded portion at the proximal end for engaging with the threaded portion of the hollow leg member, such that rotation of the bolt in one direction draws the hollow leg member in a proximal direction along the central axis and rotation in the other direction causes the threaded portion of the hollow leg portion to disengage from the threaded portion of the bolt, wherein the distal end of the bolt is configured to urge the legs radially outward; and
an engaging surface perpendicular to the central axis of the fastener arranged distally of the hollow tubular body to engage with a proximal face of the work piece and configured, when the engaging surface is urged against the proximal face of the work piece, to urge the hollow leg member into a position of engagement in which the threaded portion of the hollow leg member is engaged with the threaded portion of the bolt.

12a. The fastener of claim 12, further comprising a spacer element is translatable along the central axis of the body, arranged in abutment with the flange of the hollow leg member and extending distally out of the hollow tubular body, wherein the engaging surface is formed by a distal surface of the spacer element.

13. The fastener of claim 12, wherein the proximal end of the hollow leg member has a flange with a flat surface perpendicular to the central axis of the fastener and the spacer element has a corresponding flat surface perpendicular to the central axis of the fastener.

14. The fastener of claim 12 or claim 13, wherein, when the spacer element is urged against the proximal face of the work piece, a proximal end of the spacer element is configured to urge the hollow leg member into the position of engagement.

15. The fastener of claim 12, wherein a proximal end of the spacer element has a flange, and the hollow tubular body has a stop portion arranged to engage with the flange of the spacer element and block the spacer element from moving in a distal direction.

16. The fastener of claim 15, wherein the spacer elements is arranged within the hollow tubular body, wherein the flange of the spacer element extends radially outwards and the stop portion of the hollow tubular body extends radially inwards.

17-30. (canceled)

31. A fastener comprising;
a hollow tubular body with a proximal end and a distal end and a central axis, comprising a distally-facing stop surface at the proximal end,
a hollow leg member having a proximal end and a distal end, the leg member being translatable within the body along the central axis of the body, the leg member having a threaded portion at the proximal end and a plurality of resilient legs at the distal end and wherein each leg has a head at the distal end for engaging with a workpiece, and each leg is biased radially inwards towards the central axis,
a bolt having a proximal end and a distal end, the bolt being translatable within the body along the central axis of the body, with a proximally-facing stop surface at the proximal end and a threaded portion at the proximal end for engaging with the threaded portion of the hollow leg member, such that rotation of the bolt in one direction draws the hollow leg member in a proximal direction along the central axis and rotation in the other direction causes the threaded portion of the hollow leg portion to disengage from the threaded portion of the bolt, wherein the distal end of the bolt is configured to urge the legs radially outward; and
a spring arranged between the proximally-facing stop surface of the bolt and the distally-facing stop surface stop surface of the hollow tubular body, and configured to urge the bolt in a distal direction with respect to the hollow tubular body.

32. The fastener of claim 31, wherein the proximal end of the hollow tubular body is closed by an end wall and the distally-facing stop surface is formed by an inner face of the end wall.

33. The fastener of claim 31, wherein the distally-facing stop surface is formed by a step profile extending radially inwards from the hollow tubular body.

34. The fastener of claim 31, wherein the hollow tubular body comprises a rotatable cap at the proximal end, including the distally-facing stop surface, wherein the bolt is translatable with respect to the cap and rotatably coupled to rotate with the cap.

35. The fastener of claim 31, wherein the hollow tubular body comprises a stop portion extending radially inwards at the distal end, and the leg member comprises a flange at the proximal end.

36. The fastener of claim 35, wherein the flange of the hollow leg member includes a flat surface perpendicular to the central axis of the fastener and the stop portion of the hollow tubular body has a corresponding flat surface perpendicular to the central axis of the fastener.

37-45. (canceled)
